(19) United States
(12) Patent Application Publication
(10) Pub. No.: US 2024/0175768 A1
(43) Pub. Date: May 30, 2024

(54) EXTERNAL FORCE MEASUREMENT SYSTEM, MEASUREMENT METHOD AND ELECTRICALLY ASSISTED BICYCLE

(71) Applicant: TQ-Systems GmbH, Seefeld (DE)

(72) Inventor: Heinz Hornung, Seefeld (DE)

(21) Appl. No.: 18/268,678

(22) PCT Filed: Dec. 24, 2021
(86) PCT No.: PCT/IB2021/062298

§ 371 Date: Jun. 21, 2023

(30) Foreign Application Priority Data
Dec. 24, 2020 (EP) 20217250.8
Jun. 30, 2021 (EP) 21182653.2

(51) Int. Cl. G01L 1/22; B62M 6/50; G01D 5/14; G01L 5/00

(52) U.S. Cl. CPC G01L 1/22; B62M 6/50; G01D 5/145; G01L 5/00

(57) ABSTRACT

The external force measurement unit comprises a load cell with a support ring, wherein a first flap and a second flap are arranged on the support ring, wherein the second flap is arranged opposite to the first flap on the support ring, wherein each flap is arranged in a radial direction to the outside of the outer ring, and a first flap end and a second flap end being arranged at respective ends of the first flap and the second flap. A second aspect concerns a measuring method for measuring an external force with an external force measurement unit comprising a load cell, which receives a spindle. A third aspect concerns an electrically assisted bicycle comprising an external force measurement unit.

The present application relates to an external force measurement system, a measurement method, and to an electrically assisted bicycle.

It is an object of the present application to provide an improved external force measurement unit and measurement method.

The application provides an external force measurement unit for measuring an external force that is applied to a spindle or lower bracket of an electrically assisted bicycle. The external force measurement unit comprises a load cell with a support ring, wherein a first flap and a second flap are arranged on the support ring, wherein the second flap is arranged opposite to the first flap on the support ring.

Different from other designs, the present application provides a device for measuring the forces that are applied to the spindle by a rider of the bicycle. This is to determine the amount of additional power or torque that is applied to that spindle by an electric motor of the bicycle. Conventional designs provide devices that measure the torque that the rider of the bicycle applies to the spindle, by way of pushing cranks with pedals that are attached to the spindle. The present application provides a way to determine the amount of additional power or torque by measuring, in essence, the vertical forces on the spindle in a vertical direction.

In one embodiment, the horizontal forces on that spindle are not even taken into account in determining that amount of additional power or torque. This is done so that the amount of additional power or torque is determined solely by measuring the vertical forces on the spindle in a vertical direction.

Leaving the horizontal forces on the spindle out of the measurement means that the forces of the bicycle chain that are transmitted to the spindle by way of the front chain wheel are left out, which in turn provides a simplified way to determine that additional amount of power or torque.

The design according to the present application provides each flap in a radial direction towards the outside of the outer ring that can later be arranged in a vertical direction with respect to the ground on which the electrically assisted bicycle is expected to be operated.

A first strain gauge is arranged on the first flap and a second strain gauge is arranged on the second flap. The first strain gauge and/or the second strain gauge will change their respective resistances, depending on a change of length of the first flap and/or the second flap when the flaps are compressed or expanded by forces on the spindle.

According to the present application, an evaluation unit is provided for measuring the resistances of the first strain gauge and the second strain gauge. This is a reliable way to convert the vertical forces on the spindle into two measurement values. According to the present application, the two resistance values of the first strain gauge and the second strain gauge can be used separately, and not combined like what is conventionally known from the prior art. In the design of the present application, the two strain gauges supply two separate measurement values, which are evaluated separately. This makes it possible to determine more operational states, for example, when the upper first flap vertically detaches from a neighboring surface of a load cell carrier seat while the lower first flap is still in contact with its corresponding neighboring surface of the load cell carrier seat, or for adjusting a zero-point of the spindle within the motor housing.

When it comes to a practical application, the resistance of the first strain gauge is measured with two electrical paths or connecting wires to the control and evaluation unit. The resistance of the second strain gauge is measured with two electrical paths or connecting wires to the control and evaluation unit, wherein the first strain gauge and the second strain gauge can share one conductive path, for example, by a common ground connection with the evaluation unit.

The load cell comes further with a first bearing support for taking up a first bearing in a first bearing seat, wherein the first bearing is provided with a first outer ring being mounted to the first bearing seat to transmit a first force, wherein the external force comprises the first force, which is transmitted to the first bearing from the spindle to a first inner ring, and a second force which is taken up by an adapted second bearing. The first inner ring is connected to the first outer rolling ring through a first bearing element to transmit the first force from the adapted spindle.

If a first flap end and a second flap end are arranged at respective ends of the first flap and the second flap, it promotes a secure seating of the external force measurement unit in a motor housing, by taking up the first flap and the second flap in a load cell carrier seat in the motor housing.

The evaluation unit is further adapted to determine an offset of the external force, e.g. the weight of the spindle, a position of a lever arm of the spindle, and to determine the external force which is applied to the adapted spindle based on the measured resistance and on the determined offset of the first force.

The evaluation unit is smoothing the measured resistance of the strain gauges over time through a low pass filter, and a drift in the measured resistances of the first strain gauge and the second strain gauge over time can be determined. This enables recalibration of the first strain gauge and the second strain gauge measurement values by applying a drift compensation after a predefined time.

According to the present application, a freewheel is integrally or in a form-fitted way connected with the spindle. The freewheel is part of a freewheeling device that prevents the spindle from being connected with a chain wheel and/or an electric motor when a pre-determined operational state of the electric bicycle requires so.

The present application also provides an angular encoder to determine a radial or angular position of the spindle. The spindle position is required in order to determine when the electric motor provides what additional power or torque to the spindle. This enables a fine tuning of the power applied. While the angular decoder can be a conventional Hall sensor that is mounted at the load cell, the magnetic flux through the Hall sensor can be an annually arranged series of magnets at a neighboring section of the spindle. As an alternative, the magnetic flux through the Hall sensor can be a series of short flux groves in the spindle which are annually arranged immediately under the Hall sensor element.

Each one of these flux grooves extends longitudinally in parallel to the symmetry axis of the spindle, and these grooves are arranged on a circumference in the outer cylindrical surface of the spindle. For example, there can be 36 flux grooves arranged at angular positions every 10 degrees on the circumference in the outer cylindrical surface of the spindle, and each flux groove can have a circumferential width that corresponds to a 5 degrees segment of the outer cylindrical surface of the spindle. One reference flux groove of these 36 grooves can have a larger or smaller width than the other 35 flux grooves, or that reference flux groove has a larger or smaller depth than the other flux grooves. The Hall sensor can detect the change in magnetic flux that these flux grooves cause when the series of flux grooves moves under the Hall sensor, upon rotating the spindle while the Hall sensor stands still together with the motor housing, and the changing values of the Hall sensor signal provide an angular position of the spindle with respect to the Hall sensor and the motor housing. The reference flux groove causes a change in the Hall sensor signal that is different from the changes in the Hall sensor signal that are caused by the regular flux grooves, and that provides for detecting an absolute angular position of the spindle with respect to the Hall sensor. In other words, there is one reference flux groove of these flux grooves can have a different width in circumferential direction than the other flux grooves and/or that reference flux groove has a depth that is different from the depth of the other flux grooves.

It is also possible to provide one reference flux shoulder between these flux grooves that has a different width in circumferential direction than the flux shoulders between the other flux grooves. That wider or narrower reference flux shoulder causes a change in the Hall sensor signal that is different from the changes in the Hall sensor signal that are caused by the regular flux shoulders, and that provides for detecting an absolute angular position of the spindle with respect to the Hall sensor. In other words, there is one reference flux shoulder of these flux shoulders can have a different width in circumferential direction than the other flux grooves.

The precision of the device can be increased by using two Hall sensors and by biasing the spindle with a permanent magnet that is placed near the Hall sensors, for example, at a position immediately above the Hall sensors and above the spindle.

According to the present application, the external force measurement unit receives the spindle inside a first bearing ring of a first bearing and inside a second bearing ring of a second bearing. This is how the spindle applies a first force to the first inner bearing ring, and a second force to the second inner bearing ring, wherein the first force and the second force are parts of the external force which is applied to at least one end of the spindle, through a lever arm. The lever arm can, for example, be a crank with a pedal.

The evaluating unit calculates a calculated force dependent torque that is applied by a rider of the bicycle, and an effective lever arm length of each the lever arm, which depends on the current angular position of the spindle.

The present application provides a method for measuring an external force that measures changes of a resistance of a first strain gauge. The first strain gauge is arranged on the first flap due to a change of length of the first flap and this changes a resistance of a second strain gauge which is arranged on the second flap, due to a change of length of a second flap. The method comprises determining an offset of the external force being induced by an external force, e.g. by the weight of the spindle, determining an angular or rotational position of a lever arm of the spindle, determining the external force which is applied to the spindle, based on the measured resistances and the determined offset of the first force.

A vertical guiding assembly can be provided for the load cell.

In one embodiment of the vertical guiding assembly, the load cell has an anchor flap that protrudes with an angle of about 90° degrees from the symmetry axis of the support ring. A fixing pinhole is provided within the anchor flap, the symmetry axis of the fixing pinhole being essentially parallel to the symmetry axis of the support ring.

In a mounted state of the load cell in the motor housing, a fixing pin is inserted into the fixing pinhole and into a corresponding anchor hole in the motor housing. The fixing pin transmits horizontal forces of the load cell to the motor housing, thereby preventing the spindle from moving horizontally because of horizontal forces on the spindle, caused, for example, by the bicycle chain.

The vertical guiding assembly with the horizontal arrangement of the anchor flap, as compared with the vertical arrangement of the first flap and the second flap which carry the first strain gauge and the second strain gauge, provides that the first strain gauge and the second strain gauge are kept out of the area of deformation that these horizontal forces cause in the load cell. This arrangement improves the measurement precision of the vertical forces that are transmitted by the spindle to the load cell. The design with the anchor flap and the fixing pin in the fixing pinhole provides better measurement results of the vertical forces and reduces the numbers of parts required for achieving the decoupling of the horizontal forces on the spindle from the vertical forces in the area of the external force measurement unit.

In other embodiments of the vertical guiding assembly, the assembly provides a slit for the fixing pinhole or for the corresponding hole in the motor housing. The slit provides a vertical movement of the load cell in the motor housing, while a horizontal movement of the load cell in the motor housing is prevented. For example, the fixing pin can be provided in a fixed position in the fixing pinhole while it can vertically move in a slit in the motor housing. Alternatively, the fixing pin can be provided in a fixed position in the motor housing while it can vertically move in a slit in the fixing pinhole.

Another way to provide the vertical guiding assembly is to provide vertical protrusions in the motor housing against which the load cell abuts in a horizontal direction. The load cell can still slide upwards and downwards along the vertical protrusions, while the vertical protrusions provide a horizontal guide for the load cell that prevents a horizontal movement of the spindle.

The present application also provides an electrically assisted bicycle with an external force measurement unit as herein described.

According to a first aspect, an external force measurement unit for measuring an external force applied to a spindle is provided.

The external force measurement unit comprises a load cell with a support ring, wherein a first flap and a second flap are arranged on the support ring, wherein the second flap is arranged opposite to the first flap on the support ring, and wherein each flap is arranged in a radial direction to the outside of the outer ring. The unit also comprises a first flap end and a second flap end being arranged at respective ends of the first flap and the second flap.

The external force measurement unit further comprises a first strain gauge which is arranged on the first flap and a second strain gauge, which is arranged on the second flap, wherein depending on a change of length of the first flap or the second flap due to a material expand, the first strain gauges and/or the second strain gauge is adapted to change their respective resistance.

The external force measurement unit further comprises an evaluation unit, which is adapted to measure a resistance of the first strain gauge and the second strain gauge, which is further adapted to determine an offset of the external force being induced by the weight of the spindle, and which is further adapted to determine a position of a lever arm of the spindle and to determine the external force, which is applied to the adapted spindle based on the measured resistance and the determined offset of the first force.

The external force measurement unit further comprises a first bearing support to take up a first bearing in a first bearing seat, the first bearing with a first outer ring, wherein the first outer ring is mounted to the first bearing seat to transmit a first force, wherein the external force comprises the first force, which is transmitted to the first bearing from the spindle to a first inner ring and a second force, which is absorbed by an adapted second bearing, and the first inner ring is connected to the first outer rolling ring through a first bearing element to transmit the first force from the adapted spindle.

The external force measurement unit can be a system to measure a force that is applied from external. The external force measurement unit measures a change of resistance. Depending on the measured resistance, the external force is calculated.

The external force is applied to the external force measurement from outside of the unit. Mainly the external force can be applied by a human. For example, the external force is applied to the pedal of a bike by the foot of a person.

The pedal can be part of a bike and can rotate. So, the external force is mostly applied perpendicular to the pedal.

The spindle can be a shaft, a hollow shaft or a cylinder. The first bearing and the second bearing receive the spindle. The bearing is a machine element that constrains relative motion to only the desired motion and reduces friction between moving parts. The bearings can for example be a rolling-element bearing, a plain bearing, a ball bearing, a roller bearing, a jewel bearing, a fluid bearing, a magnetic mearing or a flexure bearing.

The load cell with the support ring is a device to receive the bearing, for example, by an engineering fit. The load cell can be made of aluminum or steel or any other suitable material. The engineering fits are used as part of geometric dimensioning and tolerancing when a part or assembly is designed. A fit is a clearance between two mating parts, and the size of this clearance determines whether the parts can, at one end of the spectrum, move or rotate independently from each other or, at the other end, are temporarily or permanently joined. The bearing can be taken up in the first bearing seat of the support ring by fixed-lot bearing arrangement, where one of the bearings is movable and the other is fixed.

The fixed bearing is mounted on the element to be supported in such a way that it cannot move in the axial direction. The locating bearing thus absorbs both radial and axial forces. The fit can also be a load-bearing support bearing, the axial force is divided between both bearings. Each of the two bearings absorbs axial force in one direction so that both bearings together can absorb all axial forces.

The first flap and the second flap are elements arranged on the load cell. Each flap can also be named a tongue or a bracket. At least the flap can transfer a force in a predefined direction. The radial direction, the flap is arranged, is pointing from the center of the load cell to the outside. Both flaps can be arranged on each side on the ends of a line through the center. So, the flaps are on opposite sides of the load cell. The flaps can partly surround the load cell. The flaps can have a gap in between.

The flap ends can also be arranged on the line through the center. The flaps ends are arranged on the proximal end to the load cell. On each proximal end of each flap is a flap end arranged. Each flap end can clamp an angle to the corresponding flap. In an example embodiment, the angle is 90° degrees.

The strain gauge is a device used to measure strain on an object. In this case, the object is each flap. A strain gauge can consist of an insulating flexible backing which supports a metallic foil pattern. As the flap is deformed, the foil is deformed, causing its electrical resistance to change. This resistance change, usually measured using a Wheatstone bridge, is related to the strain by the quantity known as the gauge factor. In an example embodiment, the strain gauge mainly measures a change of length along the radial direction.

The evaluation unit can, for example, be a microprocessor or a logic chip. The evaluation unit can be connected to each strain gauge. As described above, the evaluation unit can measure the resistances of each strain gauge. The evaluation unit can also have an output to transmit the calculated results. The output can be connected to an engine control unit to control a motor.

Through this solution, it is possible to provide a simple force measurement unit. The measurement unit has fewer components and can be easily adapted. The measurement unit can be improved in its compactness and precision. The measurement unit allows the building of more compact motor units with higher durability.

The external force measurement unit can be further improved by comprising a motor housing, wherein the first flap end and the second flap end are adapted to mount the load cell to a load cell carrier seat on the motor housing of the spindle, and the second outer ring is mounted to second rolling support of the motor housing.

The motor housing takes up the external force measurement unit. The measurement unit is mounted to the motor housing. The load cell is mounted through the flap ends to the motor housing. The second bearing can be mounted through a bearing support seat to the housing, as described above.

The motor housing can be part of a motor unit. The motor unit can comprise a motor, a battery holder, and the external force measurement unit. The external force measurement unit can be mainly enclosed by the motor housing. The load cell can also be mounted to an outer wall of the motor housing. In particular, the ends of the spindle are arranged on an outside of the motor housing. The motor housing can at least comprise two openings to mount the spindle. The motor housing can also comprise fastening elements to mount the motor housing to a rail. The rail can be part of a bike.

Through this solution, it is possible to protect the load cell environmental influences and mount it to the bike rail. Receiving the external force measurement unit in a motor using also improves the durability and can dampen shocks.

The external force measurement unit can be further improved in that the evaluation unit is smoothing the measured resistance of the strain gauges over time through a low pass filter.

The low pass filter can be analog. An analog filter can be an electronic circuit operating on continuous-time analog signals. In an example embodiment, the low pass filter is a digital filter. A digital filter is a system that performs mathematical operations on a sampled, discrete-time signal to reduce or enhance certain aspects of that signal. The digital filter can be part of the evaluation unit.

Through this solution, it is possible to improve the reliability of the measured resistances and fit them into a measurement series. Depending on the quality of the measured resistances the precision of calculating the can be improved.

The external force measurement unit can be further improved in that the evaluation unit is determining a drift in the measured resistances of the first strain gauge and the second strain gauge over time and is recalibrating the first strain gauge and the second strain gauge by applying a drift compensation after a predefined time span.

The drift is a shift of the measurement values, in particular the measured resistances, over time. The drift can be affected by warming the strain gauges, signs of fatigue due to deflection, material creep under continuous load in the order of magnitude of the measuring range in one direction or by a sensitivity drift due to aging and hardening processes of various materials, thus requiring frequent recalibrations.

The predefined time span can also be a single event. For example, if the resistance changes relative to a previous resistance more than a predefined threshold. The time span can also be defined as numerous of rotations of the spindle.

Through this solution, it is possible to improve uniformity and the comparability of the measured resistances. This leads to a more precise calculation of the external force. This improves the overall quality of the external force measurement unit.

The external force measurement unit can be further improved by comprising a freewheel, which is form-fitted connected with the spindle.

The freewheel can be an overrunning clutch. It allows disengaging a driveshaft from the driven shaft, in particular the spindle, when the driven shaft rotates faster than the driveshaft. The freewheel can be a clamping roller freewheel, a clamp body freewheel, a pawl freewheel, a claw rings freewheel, or a wrap spring freewheel. The freewheel comprises an inner part, also called a star, and an outer part. The inner part is form-fitted connected to the spindle. The inner part can transfer a force from the outer part to the spindle.

Through this solution, it is possible to decouple the motor from the spindle, when the spindle is turning faster than the motor is able or allowed to support the external force.

The external force measurement unit can be further improved by comprising an angular encoder to determine a radial position of the spindle.

The angular encoder, which is also called a rotary encoder or a shaft encoder, is an electro-mechanical device that converts the angular position or motion of a shaft or axle, to an analog or digital output signals.

The angular encoder can be an absolute encoder. The absolute encoder indicates the current spindle position. In an example embodiment, the angular encoder is an incremental encoder. The output of the incremental encoder provides information about the motion of the spindle or the change of position of the spindle. In particular, the angular encoder can be an off-axis magnetic encoder.

Through this solution, it is possible to improve the position recognition of the spindle. Using the angular encoder provides more detailed information about the position of the spindle and therefore more precise information about the position of the pedals and the pedal cranks. Thus, more detailed information corresponding to the driving situation and force management can be provided.

The external force measurement unit can be further improved in that the spindle is received inside the first bearing ring of the first bearing, and is received inside the second bearing ring of the second bearing, wherein the spindle applies the first force to the first bearing ring and a second force to the second inner bearing ring, wherein the first force and the second force are parts of the external force, which is applied to at least one end of the spindle through a lever arm.

The spindle can comprise at each side a spindle end. The spindle end can be outside of the motor housing. Each spindle end can take up the lever arm. The lever arm can be a pedal crank. The pedal crank can have a predefined length. On one side of the pedal crank, the pedal crank can be mounted to the spindle end. On the other side of the pedal crank, a pedal can be received. The external force is acting on the pedal. The pedal crank transfers the force to a spindle. The transferred force can be a torque.

Through this solution, it is possible to calculate the external force depending on the measured resistances and the lever arm length and to output a more detailed position of the pedal relative to the spindle.

The external force measurement unit can be further improved in that the evaluating unit is calculating the torque depending on the calculated force and an effective lever arm length of each lever arm, which is depending on the position of the spindle.

Depending on the position of the lever arm and the pedal, the lever arm length, which has a contribution to the torque, can change. For example, if the lever arm on each end is in a vertical position the horizontal distance between the pedal the spindle can be zero. Thus, the lever arm has hardly a contribution to the torque applied to the spindle.

While the spindle rotates, the pedal and the pedal crank also rotate. Thus, the position of the lever arm is changing over time. Depending on this change also the lever arm length, which has a contribution to the initiated torque, changes over time. The horizontal distance between the pedal and the spindle is equal to the effective lever arm length. So, the effective lever arm length can change over time depending on the pedal position.

Taking this into account, the evaluation unit is calculating depending on measured resistances and the determined first force the torque, which is applied to the spindle through the lever arm.

In case that a force is acting on both pedals, which are shifted by 180° degree on each end of the spindle, mainly the external force which is acting in the tangential direction of the spindle is turning has a contribution to the torque.

Through this solution, it is possible to calculate a more precise torque. A precise measurement of the torque is important to transmit improved torque information to an engine control unit. The engine control unit can control the motor more precisely and the motor can provide a more driving situation adapted torque to the spindle to support the external force applied by a human to the spindle of an electric bike.

According to a further aspect, a measuring method for measuring an external force with an external force measurement unit comprising a load cell, which receives a spindle is provided.

The method comprises the steps of changing resistance of a first strain gauge, which is arranged on the first flap due to a change of length of a first flap and changing resistance of a second strain gauge, which is arranged on a second flap, due to a change of length of a second flap, wherein each flap is arranged to the load cell.

The method further comprises the steps of measuring each resistance of the first strain gauge and the second strain gauge with an evaluation unit.

The method further comprises the steps of determining an offset of the external force being induced by the weight of the spindle with the evaluation unit.

The method further comprises the steps to determine a position of a lever arm of the spindle with the evaluation unit.

The method further comprises the steps to determine the external force, which is applied to the adapted spindle based on the measured resistances and the determined offset of the first force with the evaluation unit.

Through this method, a more precise and cost-efficient measuring method to determine an external force acting on a spindle is provided.

According to a further aspect, an electrically assisted bicycle is provided, comprising an external force measurement unit.

For example, an electrically assisted bicycle is a bicycle that comprises an electric motor to support or assist the driver and an energy storage, which stores energy to be provided in the form of electrical energy to the electric motor.

The electric motor can, for example, be a hub motor or a chain motor, comprising at least one DC or AC powered electrical machine. The energy storage can, for example, be a battery or an accumulator, for example, a lead, or lithium-based battery or accumulator. Alternatively, or additionally, the energy storage can be a fuel-cell storage. The electric motor provides energy in addition to a human muscle power of the driver pedaling the bicycle with an assistance factor. An example of such an electrically assisted bicycle is an electric bicycle, such as an e-bike or pedelec.

Through this solution, it is possible to provide an electrically assisted bicycle, which has a motor unit with a load cell to measure the resistance of a strain gauge. The load cell provides an improved external force measurement unit, which is enhanced in its simplicity. So, accuracy is improved, and the manufacturing costs are decreased.

With regards to the advantages of the method and the electrically assisted bicycle, reference is made to the external force measurement unit and the embodiments as described above.

It will be readily understood that individual or all steps of the method can be performed by the external force measurement unit and vice versa.

According to a further aspect, a motor unit for an electrically assisted bicycle is provided, comprising a free wheel an outer ring, an inner ring and a sprocket carrier.

The free wheel is adapted to decouple the sprocket carrier from the outer ring. Decoupling means that the inner ring can rotate with a different speed in comparison to the sprocket carrier.

Through this solution, an external applied force to the sprocket carrier is not transmitted to the inner ring in case the external force results in a faster turning speed than the speed of the inner ring. This leads to reduced friction loss.

The motor unit can be further improved by comprising one free wheel.

The motor unit comprises not more than one free wheel. In particular, the motor unit comprises not less than one free wheel. The number of the free wheel can be equal to one.

The motor unit with only one free wheel enables one to build a even more compact and smaller motor unit.

Further the motor unit comprises a motor housing, which takes up the free wheel, the outer ring, the inner ring and the sprocket carrier.

The motor housing can be made of plastic or metal. The motor housing can be shockproof and/or waterproof. The motor housing can protect the free wheel, the outer ring, the inner ring and the sprocket carrier against environmental influences.

In a further embodiment, an electric motor comprises a rotor, wherein the rotor is mounted to harmonic pin ring drive.

The harmonic pin ring drive provides a small gear between the electric motor and the spindle. Minimizing the size of the gear enables to minimize the drive unit.

The motor housing can comprise a first motor housing part, a second motor housing part and a third motor housing part.

The first motor housing part can be a gear box and an exterior edging. The second motor housing part is adapted to take the load cell. The third motor housing part is adapted to take up the sprocket carrier.

Through this solution, the motor housing can be fitted to a frame of a bicycle. Further, a size of the motor housing can be reduced.

In a further aspect, the electrically assisted bicycle comprises a motor unit, as described above.

The electrically assisted bicycle can comprise a frame. The housing of the motor unit can be mounted to the frame. The motor housing can also be integrated into the frame. The motor housing can take up the motor unit.

Reducing the size of the motor housing leads to improved driving characteristics.

In a further aspect a drive method is adapted to control an electric motor of a motor unit comprising the following steps:
determining a second torque with an external force measurement unit, wherein the second torque is applied to a spindle through a crank,
calculating a first torque based on the second torque and
controlling an electric motor based on the calculated second torque.

For example, the drive method can be applied to a drive unit, as described above. In particular, the drive unit can be built-in an electrically assisted bicycle. The electrically assisted bicycle is driven by a user. The user applies a force to a pedal crank trough a pedal. Regarding to the measuring method, described above, a second torque is detected. The second torque can be applied by the user.

Depending on a gain factor, the first torque is calculated. The first torque is provided by the electric motor. The first torque is applied through the free wheel to the spindle.

Further, the drive method comprises a step, wherein the turning direction of the spindle is determined.

Determining the turning directions enables one to control the turning direction of the motor. By controlling the motor in both turning directions a support can be provided for each turning direction of the spindle.

With regards to the advantages of the method, the electrically assisted bicycle and the external force measurement unit, reference is made to the motor unit and the drive method.

The application also provides an electrically assisted bicycle with an electric drive that comprises an external force measurement unit.

The application provides an electrical assisting drive that is stable. There is no factory re-calibration required for a long time. The sensitivity of the sensors remains stable over a long time. The signals of the unloaded strain gauges are negative and they have a low saturation. Small offset values are required, and the conversion from the measurement signals to the control signal for the electric motor is linear. There is a small hysteresis, as compared with other designs.

Embodiments of the application will now be described with reference to the attached drawings, in which

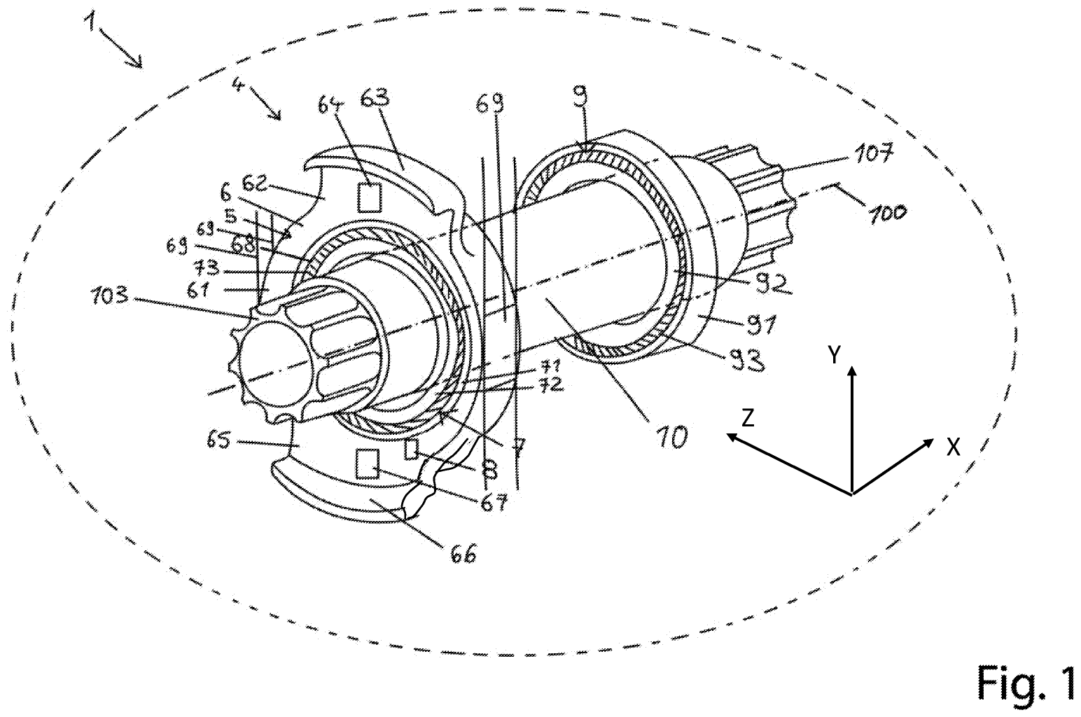

FIG. 1 shows a motor unit 1 comprising an external force measurement unit,

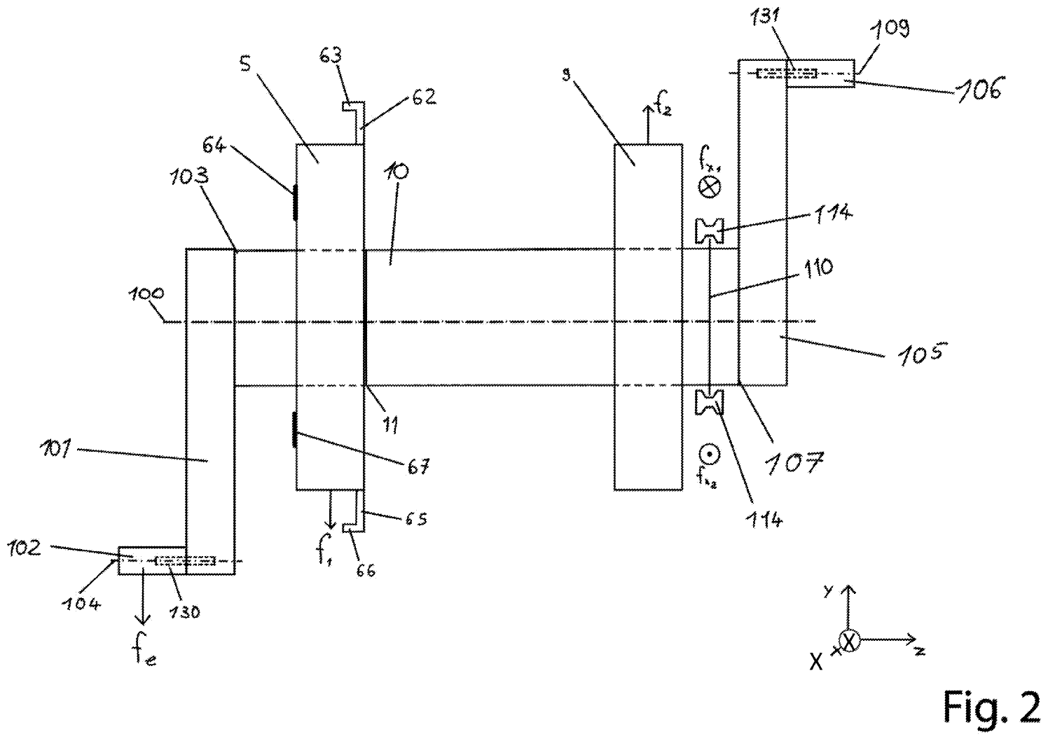

FIG. 2 shows a schematical side view of the motor unit of FIG. 1,

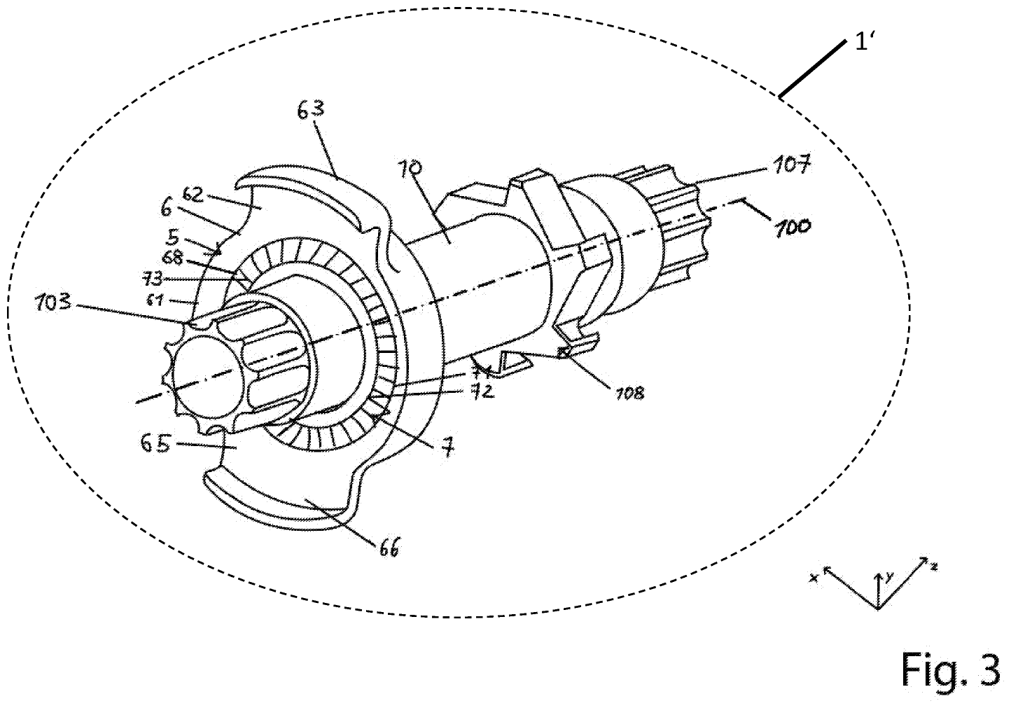

FIG. 3 shows the motor unit of FIG. 1 with a freewheel in a perspective view on a front side with the first end,

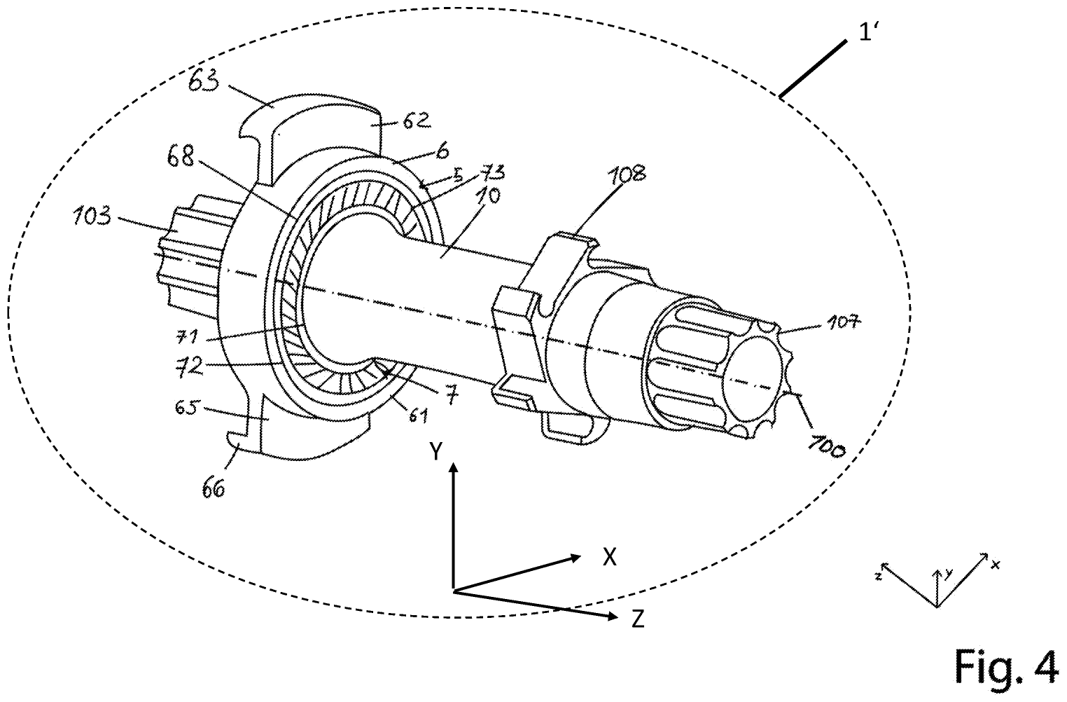

FIG. 4 shows the motor unit of FIG. 3 with the freewheel in a view on a backside with a second end,

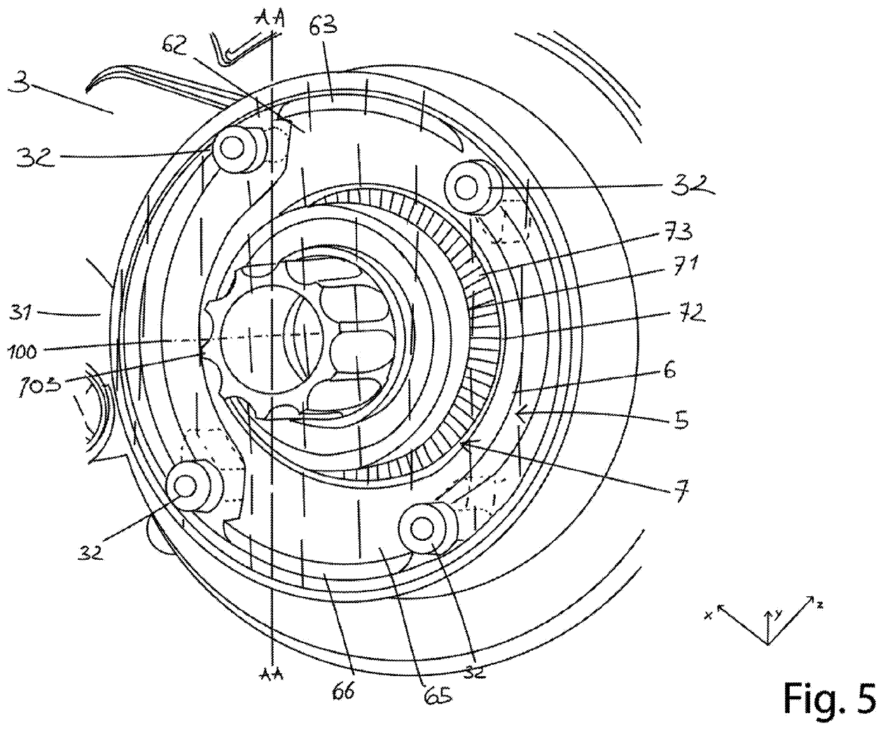

FIG. 5 shows the motor unit of FIG. 4 with a motor housing that takes up the external force measurement unit with a load cell and a spindle,

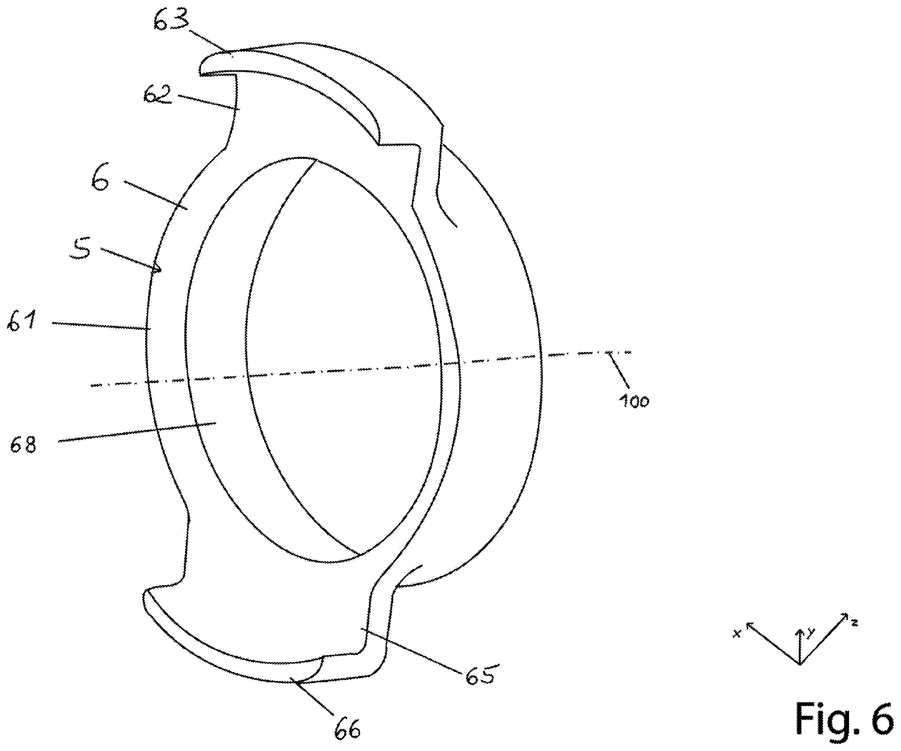

FIG. 6 shows a load cell in a perspective front view from the first end of the spindle as shown in FIG. 3,

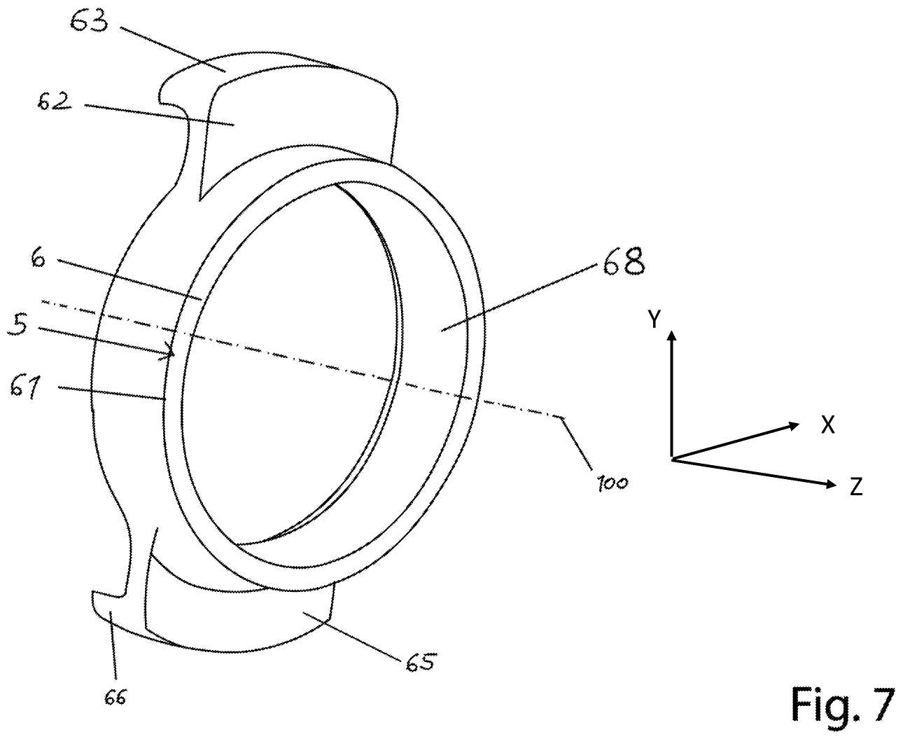

FIG. 7 shows the load cell in a perspective back view from the second end of the spindle as shown in FIG. 4,

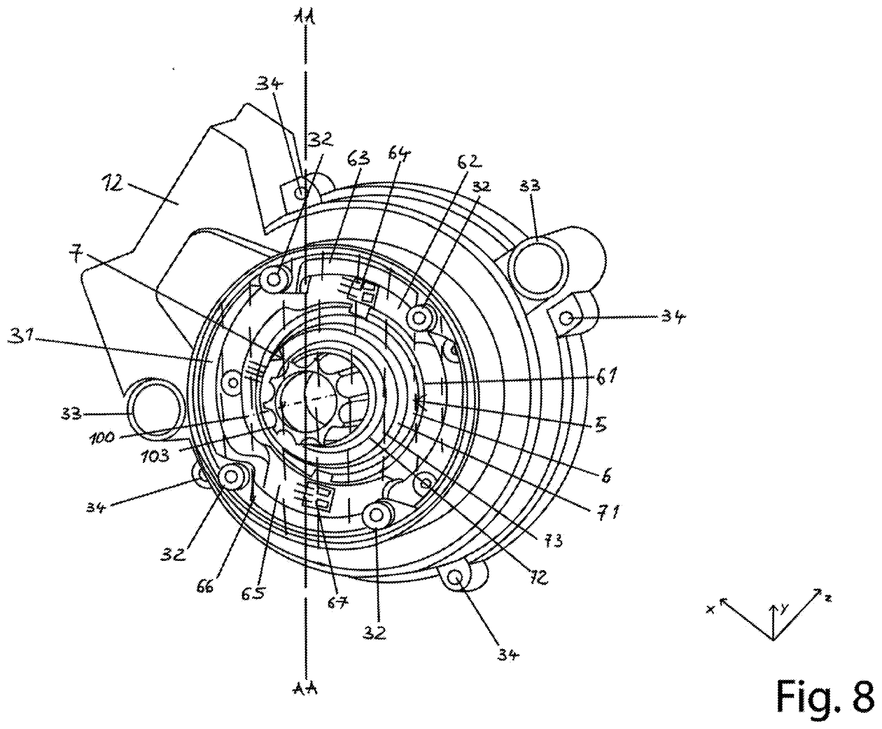

FIG. 8 shows the motor unit with a motor housing as shown in FIG. 5 with first fastening elements and second fastening elements,

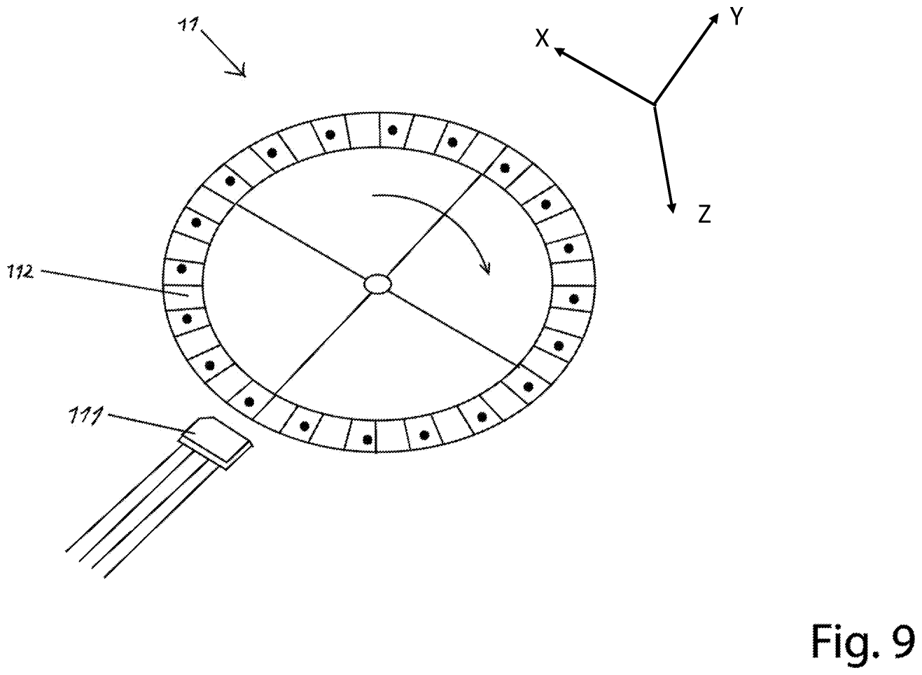

FIG. 9 shows an angular encoder with a hall sensor and a magnetic ring,

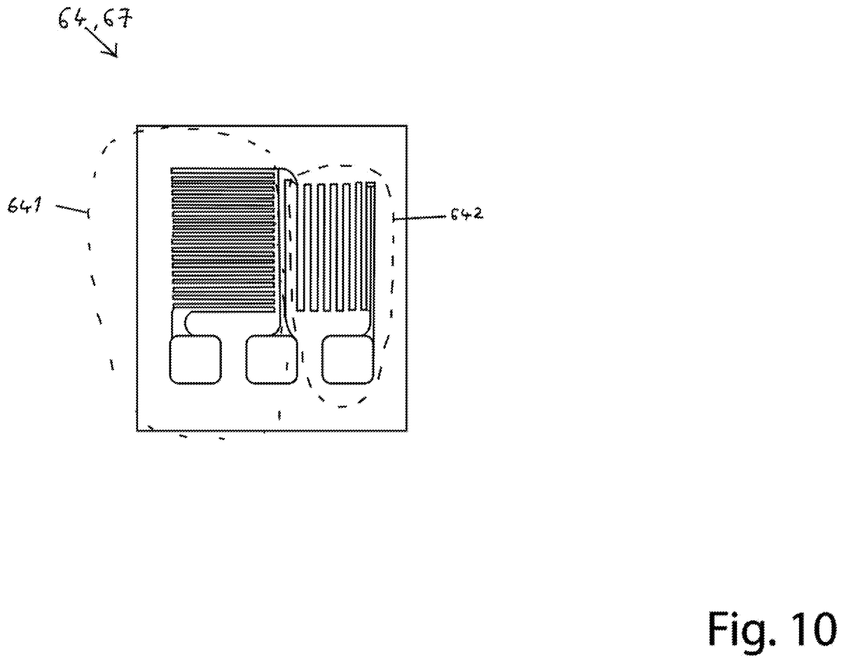

FIG. 10 shows the strain gauge of FIG. 1 in greater detail,

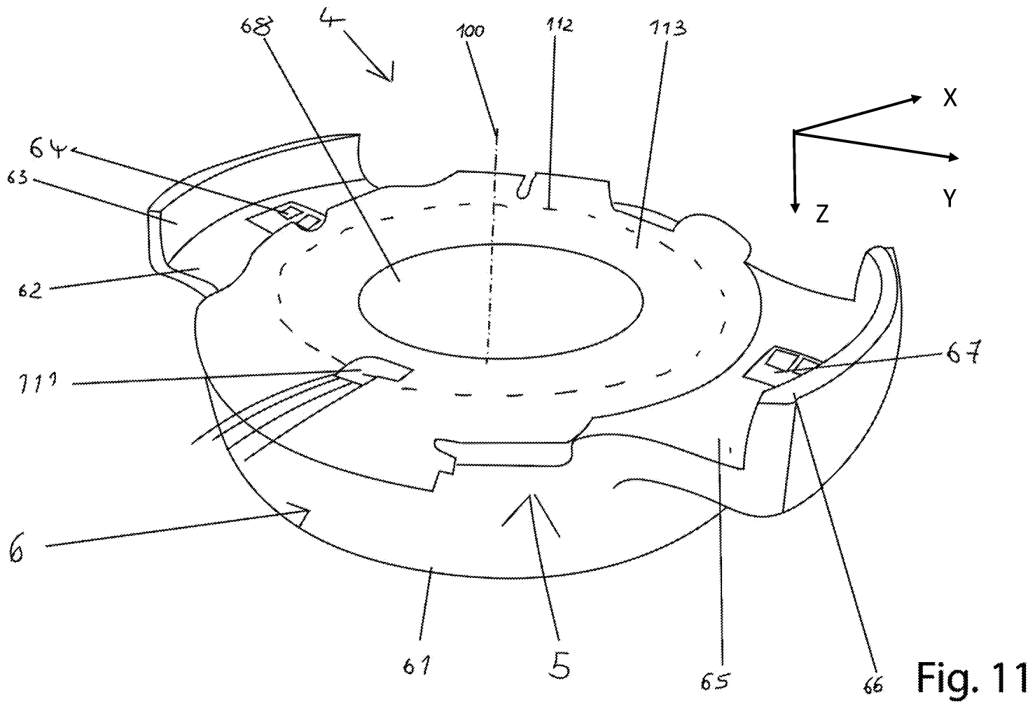

FIG. 11 shows the external force measurement unit assembled with the hall sensor of the angular detector in a front view,

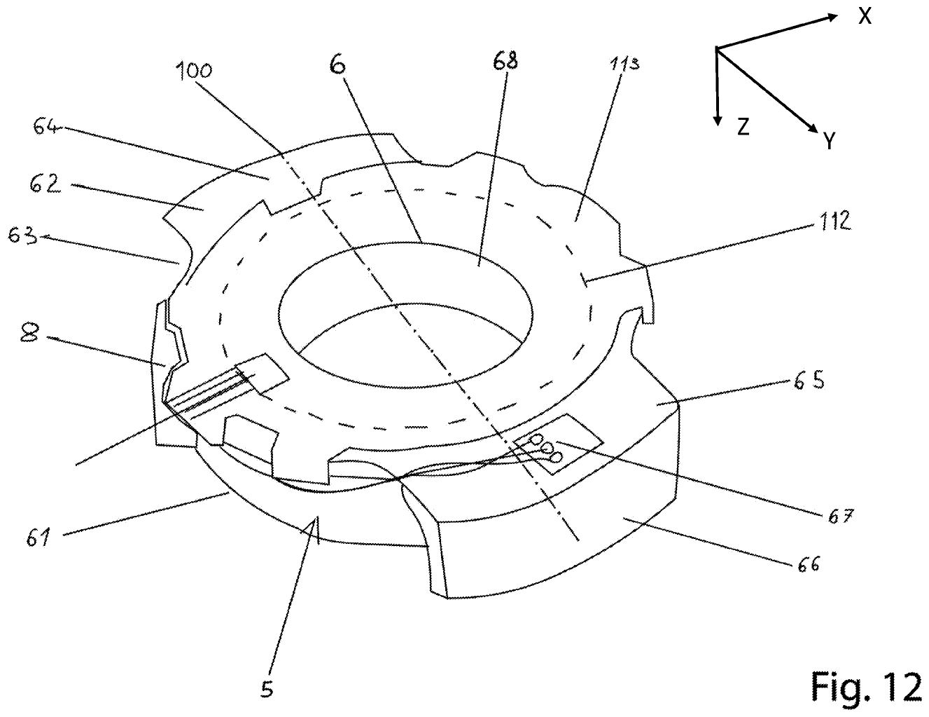

FIG. 12 shows another embodiment of an external force measurement unit assembled with the hall sensor of the angular detector in a back view,

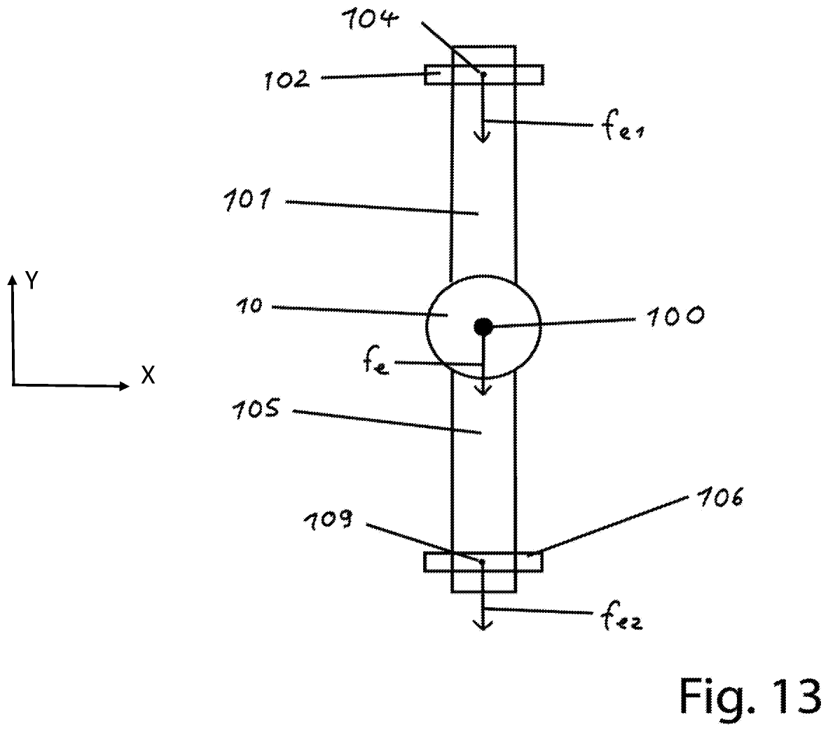

FIG. 13 schematically shows the spindle in a side view with pedals and pedal cranks in a vertical position, while external forces fₑ act on the pedals,

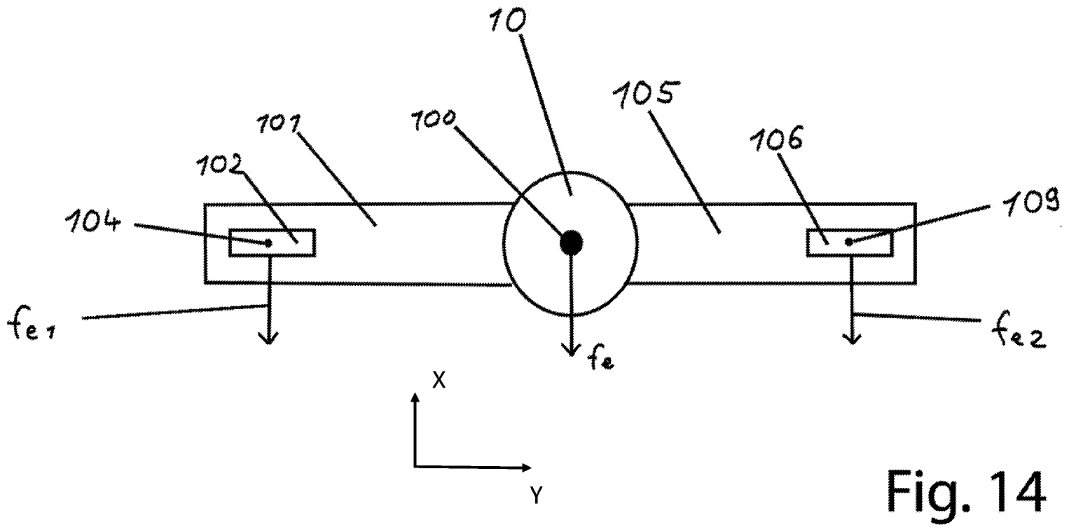

FIG. 14 schematically shows the spindle in a side view with pedals and pedal cranks in a horizontal position, while external forces fₑ act on the pedals,

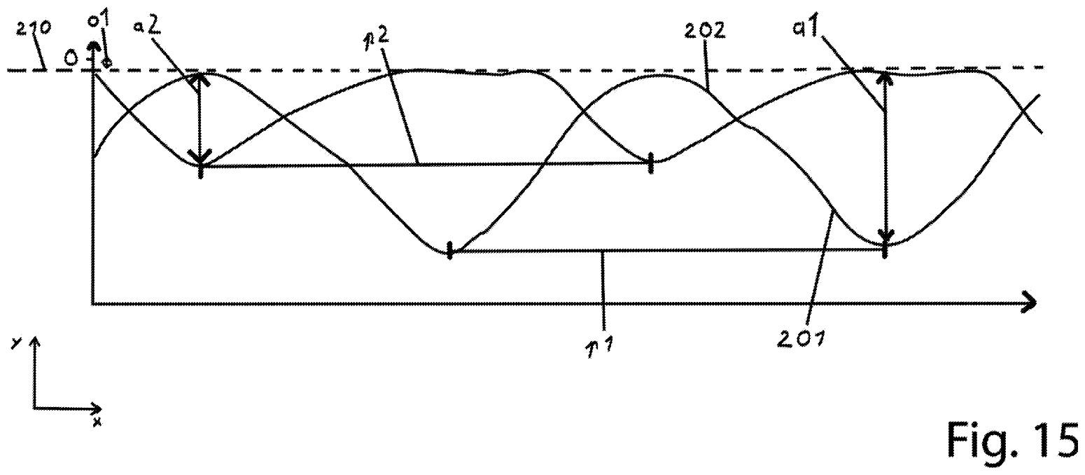

FIG. 15 shows a graph with a typical signal of measured resistances of each strain gauge mapped to the rotational angle of each pedal crank,

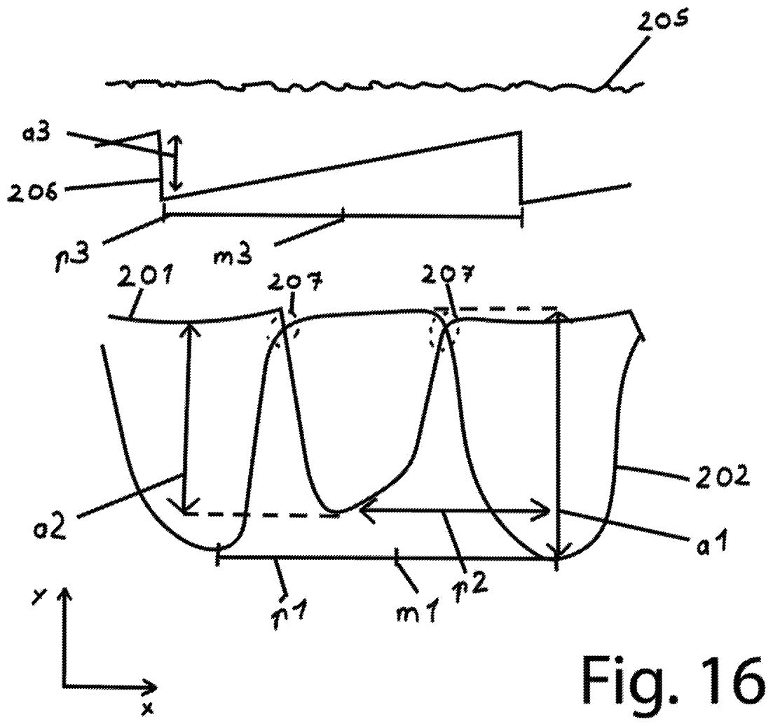

FIG. 16 shows a graph of measured resistances of each strain gauge, mapped to each pedal crank, for a low cadence without motor support,

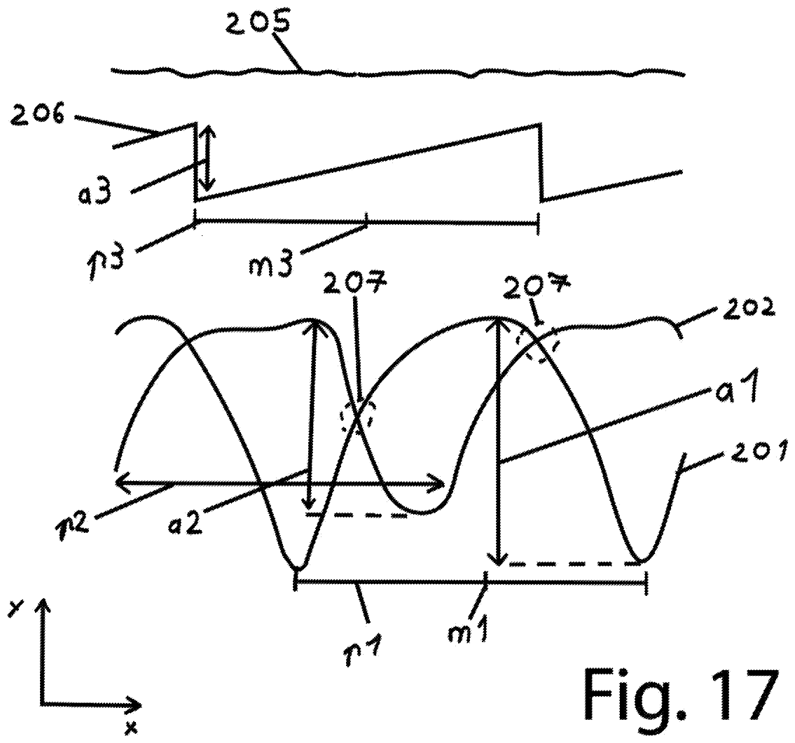

FIG. 17 shows a graph of typical signals of measured resistances of each strain gauge, mapped to each pedal crank, for a high cadence without motor support,

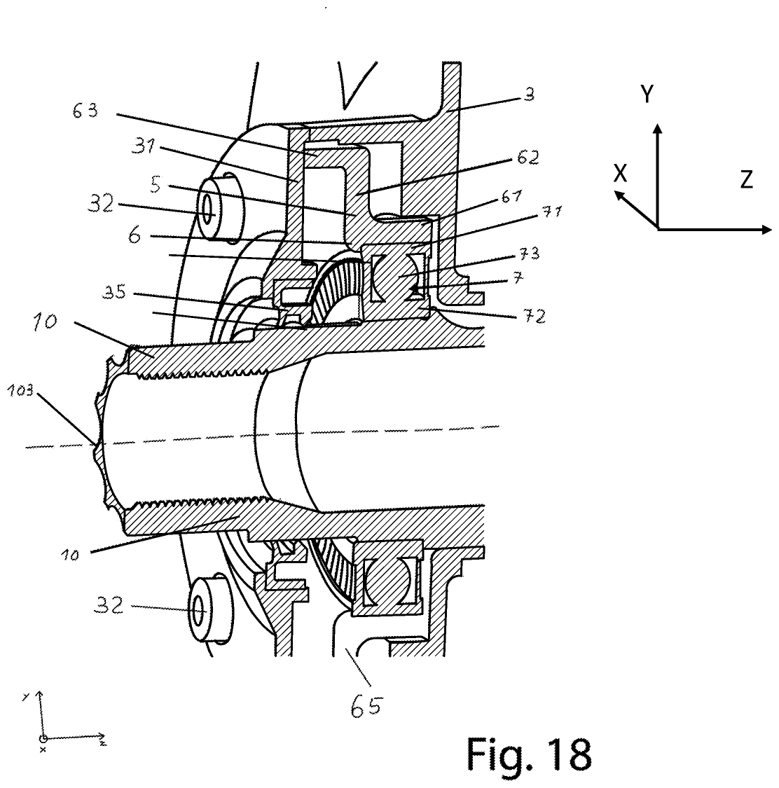

FIG. 18 shows a cross-section through the load cell with the spindle, both being mounted in the motor housing, along the intersection line “AA” of FIG. 8,

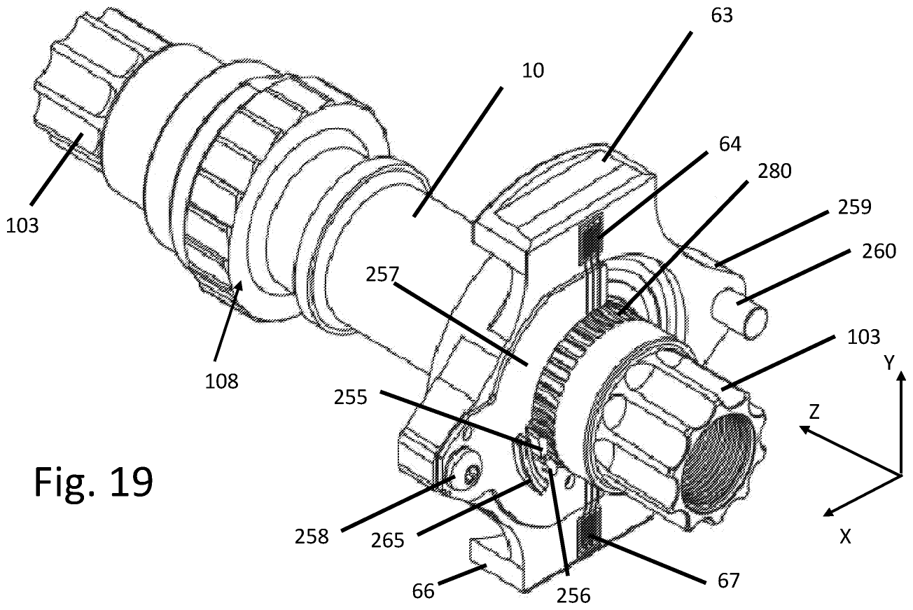

FIG. 19 shows a perspective view of a further external force measurement unit,

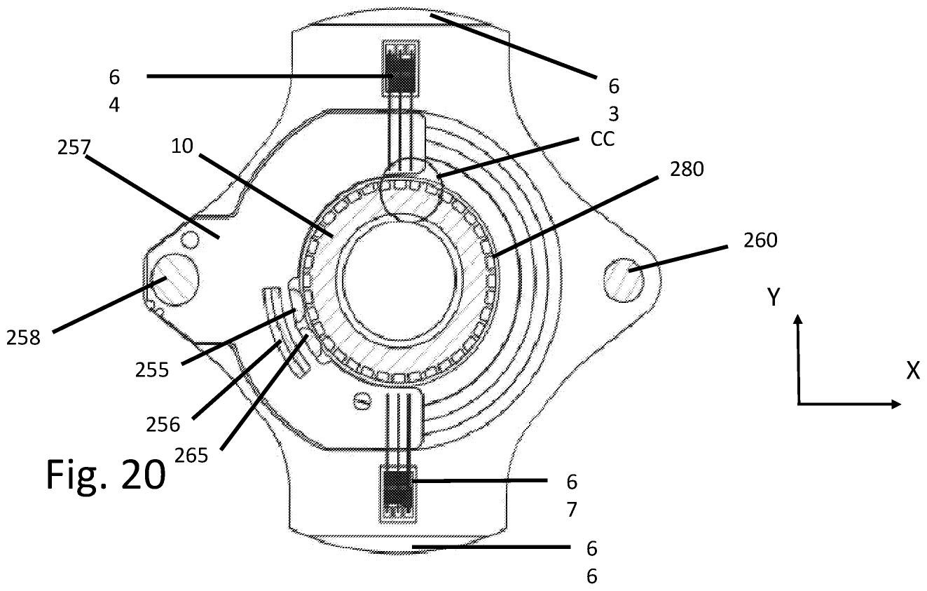

FIG. 20 shows a front view of the external force measurement unit of FIG. 20, and

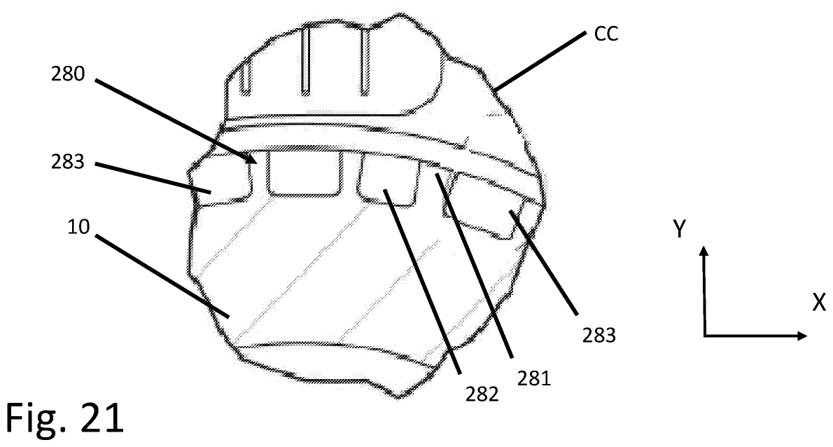

FIG. 21 shows a detail view of the area marked as “CC” in FIG. 20.

In the figures, the same or similar features are referenced by the same reference numerals and/or terms.

FIG. 1 shows a motor unit 1 or electrical drive that comprises an external force measurement unit 4.

The external force measurement unit 4 comprises a load cell 5 with a first bearing support 6. The first bearing support 6 comprises a support ring 61. A first flap 62 is integrally arranged on the support ring 61. The support ring 61 is also part of the load cell 5. The first flap 62 partially surrounds the support ring 61. The first flap 62 is arranged on an opposite side to a second flap 65. The second flap 65 is also integrally arranged on the support ring 61 and it partially surrounds the support ring 61. The first flap 62 and the second flap 65 have an equal size. The first flap 62 and the second flap 65 are arranged in a radial direction with respect to the support ring 61, on an outer side of the load cell 5.

The first flap 62 is protruding with an angle of about 90° degrees from the symmetry axis 100 of the support ring 61. Also, the second flap 62 is protruding with an angle of about 90° degrees from the symmetry axis 100 of the support ring 61.

A first flap end 63 is arranged on an outer end of the first flap 62, and a second flap end 66 is arranged on an outer end of the second flap 65.

The first flap 62 comprises a first strain gauge 64 in an area between the first flap 63 and the support ring 61, and the second flap 65 comprises a second strain gauge 67 in an area between the second flap 65 and the support ring 61.

The first bearing support 6 also comprises a first bearing seat 68, which takes up a first bearing 7. The first bearing 7 comprises a first outer ring 71 and a first inner ring 72. at least one first bearing element 73 is arranged between the first outer ring 71 and the first inner ring 72.

An evaluation unit 8 is arranged on the load cell 5.

The motor unit 1 also comprises a second bearing 9. The second bearing 9 comprises a second outer ring 91. The second outer ring 91 is taken up in a support bearing seat, which is not shown here, and a second inner ring 92. At least one second bearing element 93 is arranged between the second outer ring 91 and the second inner ring 92.

The first inner ring 72 of the first bearing 7 and the second inner ring 92 takes up a spindle 10 with a spindle symmetry axis 100 as shown in FIG. 1. The spindle 10 comprises a first end 103 and a second end 107.

The motor unit 1 also comprises an angular encoder, which is not shown here, for detecting the change of the angular position of the spindle 10. In an embodiment not shown here, the angular encoder detects the absolute angular position of the spindle 10.

The load cell 5 also comprises mechanical guiding 69. The mechanical guiding 69 lock a movement of the loadcell 5 in x-direction and z-directions.

In an embodiment, the mechanical guiding 69 are on an outside of the load cell 5 in an 90°-degree angle next to each flap. The mechanical guiding 69 is comprising a plastic pin, which is not shown here, which locks the movement of the load cell 5 in in x-direction and z-directions. The plastic pin is arranged on the mechanical guiding and runs a long a guidance, which is arranged on the loading cell carrier seat 51.

In a further embodiment each flap end 63, 66 a plastic pin on each end along the z-axis. The plastic pins are running in a guidance. This mechanical guiding also locks the movement of the load cell at least in x-direction.

FIG. 2 shows a schematical side view of the motor unit 1 of FIG. 1.

The first end 103 of the spindle 10 is provided with a first crank 101, being connected by a first pedal spindle 130, with a first symmetrical axis 104 as shown in FIG. 2, to a first pedal 102. The first pedal 102 is rotatable around the first symmetrical axis 104 and transfers a rider's force to the first crank 101. Likewise, the second crank 105 is connected through a second pedal spindle 131 with a first symmetrical axis 109, as shown in FIG. 2, to a second pedal 106. The second pedal 106 is rotatable around the second symmetrical axis 109, as shown in FIG. 2, and transfers a rider's force to the first crank 101.

FIG. 2 also shows the angular encoder 11. The angular encoder 11 is mounted to the load cell 5 which also takes up the first bearing 7 (not seen here). The angular encoder 11 is arranged between the first bearing 7 and the second bearing 9. The angular encoder 11 is arranged on the load cell 5 such that it stands still with the motor housing 3.

The first pedal 102 transfers an external force fₑ to the spindle 10. Further, the spindle 10 transfers a first force f₁ and a second force f₂ to the second bearing 9 and to the first bearing 7. Also, a first horizontal force fₓ₁ and a second horizontal force fₓ₂ are transferred from a chain 114 to a deflector blade 110 that is arranged as a toothed front wheel of the bicycle on the spindle 10.

The deflector blade 110 is mounted to the spindle 10. The first force fₓ₁ and the second force fₓ₂ are essentially perpendicular to the external force fe, the first force f1 and the second force f₂. The external force fe, the first force f₁, and the second force f₂ act along a y-axis. Forces working along the y-axis are vertical forces here.

The first horizontal force fₓ₁ and the second horizontal force fₓ₂ act along an x-axis. The first horizontal force fₓ₁ and the second horizontal force fₓ₂ act in a horizontal direction.

FIG. 3 shows a motor unit 1′ as shown in FIG. 1, but with a freewheel 108.

On one side of the first bearing 7, the spindle 10 comprises the first end 103. On the other side of the first bearing 7, the spindle 10 comprises the freewheel 108 and the second end 107. The freewheel 108 is a roller freewheel. A star of the freewheel 108 is provided as a form-locked connection to the spindle 10. It is also possible to provide the star integrally on the spindle, as one single piece with the spindle.

FIG. 4 shows the motor unit 1′ of FIG. 3 with the freewheel 108 in a view from a backside with a second end 107.

The freewheel 108 comprises a freewheel clutch that is not shown here. The freewheel clutch has spring-loaded rollers, inside a driven cylinder. At least one of several parts of the star has on one side a slant. On the opposite side, the star has an edge in radial direction of the spindle 10. The edge is next to the spindle 10. A proximal edge is tangentially arranged to the spindle 10. A cover covers the front side of the freewheel 108. Each part of the star comprises next to the radial side a notch. The notch is arranged on the averted side from the slant.

In another embodiment not shown here, the freewheel is a clamping freewheel. The clamping freewheel comprises at least two saw-toothed, spring-loaded discs which are pressing against each other with the toothed sides together, like a ratchet. Rotating in one direction, the saw teeth of the drive disc lock with the teeth of the driven disc, making it rotate at the same speed.

FIG. 5 shows a motor unit 1 with a motor housing 3, taking up the external force measurement unit 4 with the load cell 5 and the spindle 10.

The motor housing 3 is taking up the motor unit 1. The motor unit 1 is mounted to the motor housing 3 through a holding plate 31 with four screws 32. The holding plate 31 is holding the first flap end 63 and the second flap end 66. The first flap end 63 and the second flap end 66 are clamped between the motor housing 3 and the holding dish 31 through the screws 32. Due to the clamping of the first flap end 63 and the second flap end 66 each flap 62, 65 is also fixed.

Due to the fixing of each flap 62, 65, the load cell 5 with the first bearing support 6 and the support ring 61 is fixed in a load cell carrier seat 51, which is not shown here, of the motor housing 3. The motor housing 3 is also comprising a support bearing seat, which is not shown here, to mount the second bearing, which is also not shown here.

The spindle comprises the first end 103, which is pointing away from the motor housing 3.

As can be best seen in FIG. 5, in a mounted state of the load cell 5 in the motor housing 3, distance pieces made from plastic or aluminum (not shown here) can be inserted between the lateral sides of the first flap 62 and the neighboring screws 32, and between the lateral sides of the second flap 65 and the neighboring screws 32. These distance pieces transmit horizontal forces of the load cell 5 to the motor housing 3, thereby preventing the spindle 10 from moving horizontally because of horizontal forces on the spindle 10, caused for example by the bicycle chain.

FIG. 6 shows the load cell 5 in a front view from the first end 103 of the spindle 10 as shown in FIG. 3.

An edge between the support ring 61 and the first bearing seat 68 is rounded off.

Each flap 62, 65 has less than half a size of the support ring 61 in direction of the spindle symmetrical axis 100. One side in direction of the spindle symmetrical axis 100 of each flap 62, 65 is arranged on the same plane as the support ring 61. The opposite side is connected to the support ring through a smooth connection.

Each flap end 63, 66 is arranged on a proximal end to the support ring 61. The flap ends 63, 66 are curved in nearly the same shape as the support ring 61. Edges of each flap end 63, 66 are rounded off. The flap ends 63, 66 are pointing towards the front side of the load cell 5. The flap ends 63, 65 have nearly the same width as each flap 62, 64.

FIG. 7 shows the load cell 5 in a back view from the second end 107 of the spindle 10 as shown in FIG. 4.

The support ring 61 relates to a leading edge to the first bearing seat 68. The leading edge is arranged inside the first bearing seat 68.

FIG. 8 shows a motor unit 1 with a motor housing 3 as shown in FIG. 5 with first fastening elements 33 and second fastening elements 34.

The first fastening elements 33 and the second fastening elements 34 are arranged on an outside of the motor housing 3. The first fastening elements 33 and the second fastening elements 34 are used to mount the motor housing 3 to a bicycle frame which is not shown here.

The first two fastening elements 33 are arranged on opposite sides of the motor housing 3. One of the two first fastening elements is arranged next to the outside of a battery holder 12 of the motor housing 3.

The second fastening elements 34 are arranged in a rectangle shape. One of the four second fastening elements 34 is arranged next to the first fastening element 33, which is positioned on the opposite side of the first fastening element 33, which is next to the battery holder 12.

The first fastening elements 33 have a bigger diameter than the second fastening elements 34.

The battery holder 12 is also part of the motor housing 3. The battery holder 12 is arranged on the perimeter of the motor housing 3 between both first fastening elements 33.

FIG. 9 shows the angular encoder 11 comprising a hall sensor 111 and a magnetic ring 112.

The magnetic ring comprises 72 north poles and 72 south poles. The north poles and the south poles are alternating on the magnetic 112. A change from one pole to the pole is equal to a 2.5° Degree change of position of the magnetic ring.

While the magnetic ring 112 is rotating and the hall sensor 111 is in a fixed position the poles are alternating. The hall sensor 111 measures a magnetic field. The hall sensor 111 detects the change of the magnetic field. So, each switch from south sole to north pole and the other way around is detected. The magnetic ring 122 is arranged to the spindle 10. Depending on the change of position of the magnetic ring 112 relative to the hall sensor 111 a change of position of the spindle 10 is detected.

In another embodiment, the angular encoder is an on-axis magnetic encoder. A on-axis magnetic encoder uses a specially magnetized 2 pole neodymium magnet attached to the motor shaft. Because it can be fixed to the end of the shaft, it can work with motors that only have 1 shaft extending out of the motor body.

In a further embodiment, a hull of the spindle 10 is comprising (in a sectional view) a tooth shape. The hall sensor 111 can be arranged directly above the tooth shape. Upon rotation of the spindle 10, a hill and a valley of the tooth shape are alternating under the hall sensor 111. Changing from a hill to a valley and the other way around changes the magnetic field.

FIG. 10 shows the strain gauge 64, 67 of FIG. 1 in greater detail.

The first strain gauge 64 and the second strain gauge 67 are designed as two-axis strain gauges. A two-axis strain gauge is measuring a change of length in one first direction with a second part 642 of the two-axis strain gauge 64, 67. The two-axis strain gauge is also measuring a change of length in a second direction, which is perpendicular to the first direction with a first part of the two-axis strain gauge 64, 67.

In one embodiment, the first strain gauge 64 is used as shown in FIG. 1, only the first part 641 being used to measure a change of length of the first flap 62 between the support ring 61 and the first flap end 63.

When the second strain gauge 67 is used as shown in FIG. 1, only the first part 642 is used to measure a change of length of the second flap 65 between the support ring 61 and the second flap end 66.

The first part 641 of the first strain gauge 64 and the first part 642 of the second strain gauge 67 are measuring a vertical change of length in a y-direction, as shown in FIG. 10.

FIG. 11 shows the external force measurement unit 4 assembled with the hall sensor 111 of the angular detector 11 in a front view.

The magnetic ring 112 and the hall sensor 111 of the angular detector 11 are arranged on the front side, as shown in FIG. 6. The magnetic ring 112 is rotatably arranged on the support ring 61 of the bearing support 6. The magnetic ring 112 is rotatably arranged while the hall sensor 111 is fixed. The hall sensor 111 is arranged to detect the changes of the magnetic field from the magnetic ring 112.

A plastic cover 113 is covering the magnetic ring 111. The plastic cover 113 has a notch, and the hall sensor 112 is arranged in the notch.

While the angular decoder can be a conventional Hall sensor 111 that is mounted at the load cell, the magnetic flux through the Hall sensor 111 can be an annually arranged series of magnets in the form of the magnetic ring 112 at a neighboring section of the spindle immediately under Hall sensor 111.

As an alternative to the magnetic ring 112, the magnetic flux through the Hall sensor 11 can also be an annually arranged series of short flux groves in the spindle 10, immediately under the Hall sensor element 111, but not shown in FIG. 9. The spindle 10 then has to be provided with magnetic material that causes the Hall sensor 111 to issue a signal upon rotation of the spindle 10. Each one of these flux grooves extends longitudinally in parallel to the symmetry axis of the spindle 10, in z-direction, and these flux grooves are arranged on a circumference in the outer cylindrical surface of the spindle 10. For example, there can be 36 flux grooves arranged at angular positions every 10 degrees on the 360 degrees circumference in the outer cylindrical surface of the spindle 10, and each flux groove can have a circumferential width that corresponds to a 5 degrees segment of the outer cylindrical surface of the spindle 10. One reference flux groove of these 36 grooves can have a larger width in circumferential direction than the other 35 flux grooves, or that reference flux groove has a larger depth than the other flux grooves. The Hall sensor 111 can detect the change in magnetic flux that these flux grooves cause when the series of flux grooves moves under the Hall sensor 111, upon rotating the spindle 10 while the Hall sensor 111 stands still together with the motor housing 3, and the changing values of the Hall sensor signal provide an angular position of the spindle with respect to the Hall sensor 111 and the motor housing 3. The reference flux groove causes a change in the Hall sensor signal that is different from the changes in the Hall sensor signal that are caused by the regular flux grooves, and that provides for detecting an absolute angular position of the spindle 10 with respect to the Hall sensor 111.

FIG. 12 shows another embodiment of the external force measurement unit 4, assembled with the hall sensor 111 of the angular detector 11 in a back view.

The magnetic ring 112 and the hall sensor 111 of the angular detector 11 are arranged on the backside, as shown in FIG. 7. Also, the first strain gauge 64 and the second strain gauge 67 are arranged on each backside of the flap 62, 65.

The evaluation unit 8 is attached to the load cell 5. The evaluation unit 8 is connected to the first strain gauge 64, the second strain gauge 67 and the hall sensor 111.

The magnetic ring 112 is arranged on a backside of the support ring 61. The hall sensor 111 is fixed. The hall sensor 111 is arranged to detect the change of the magnetic field from the magnetic ring 112.

A plastic cover 113 is covering the magnetic ring 111. The plastic cover 113 has a notch. The hall sensor 112 is arranged in the notch.

FIG. 13 shows a schematic side view of the spindle 10, with the pedals 102, 106 and the pedal cranks 101, 105, while a first external force fₑ₁ acts on the first pedal 102 and a second external force fₑ₂ acts on the second pedal 106. The load cell 5 with the first ball bearing 7 is not shown here.

In this view, the pedal cranks 101, 105 are in a vertical position, along the y-axis. The first pedal 102 provides the first external force fₑ₁ through the first pedal crank 101 to the spindle 10. The second pedal 106 transfers the second external force fₑ₂ through the second pedal crank 105 to the spindle 10.

The first external force fₑ₁ and the second external force fₑ₂ are part of the external force fₑ, which acts on the spindle 10. Each external force fₑ₁, fₑ₂ is acting in the same vertical direction.

FIG. 14 shows a schematic side view of the spindle 10 with the pedals 102, 106 and the pedal cranks 101, 105 in a horizontal position. The load cell 5 with the first ball bearing 7 is not shown here.

In this view, the pedal cranks 101, 105 are in a horizontal position. The first external force fₑ₁ acts on the first pedal 102 and the second external force fₑ₂ acts on the second pedal 106. Each pedal transfers the external force fₑ₁ and fₑ₂ through each corresponding pedal crank 101, 105 to the spindle 10. Each external force fₑ is acting in the same vertical direction. The first external force fₑ₁ and the second external force fez are part of the external force fₑ, which acts on the spindle 10.

FIG. 15 shows a graph of typical signals of measured resistances of each strain gauge 54, 67, mapped to each pedal 102, 106, over the angular position of the spindle 100

The graph is a line diagram. The y-axis represents the respective resistance and the x-axis represents time.

The first signal 201 shows a course of the resistances mapped to the first pedal 102. Two periods p1 of the first signal are plotted. The first signal has the first period p1 and a first amplitude a1. The first signal 201 is nearly a sinus function. The first signal is nearly shifted in the negative y-direction by one first amplitude a1.

The second signal 202 shows a course of the resistances mapped to the second pedal 106. Two periods p2 of the first signal are plotted. The second signal 202 has a second period p2 and a second amplitude a2. The second signal 202 is nearly a sinus function. The second signal is nearly shifted in the negative y-direction by one-second amplitude a2. The second signal 202 has at its maximum a plateau. The plateau has nearly half of the length of the second period p2.

The first signal 201 is shifted by nearly half a period p1, p2 to the second signal 202. The second amplitude p2 is nearly half of the first amplitude p1. The first period p1 and the second period p2 are nearly equal.

The maxima of each signal 201, 202 are arranged on a baseline 210. Additional to the shift in y-direction, each signal 201, 202 has an offset o1. The offset o1 corresponds to a shift between the baseline 210 and the zero-point.

FIG. 16 shows a graph for typical signal of the resistances mapped to each pedal 102, 106 for a low cadence of the pushing rider, without motor support.

A hall sensor signal 205 shows the changing of the magnetic field measured with the angular detector 11. Each change of the hall sensor signal 205 corresponds to a change of the magnetic field due to a change of the detected poles of the magnetic ring 112.

A ramp function 206 shows the calculated relative position of the spindle 10. The ramp function 206 is calculated based on the hall sensor signal 205. A middle m3 of a ramp period p3 is arranged on nearly the same x-position as a middle m1 of the first period p1. Also, the minimum of the second signal 202 is nearly at the same x-position as the middle m1 of the first period p1.

Each signal 201, 201 has a plateau on its maximum. The maximum has nearly the size of half the first period p1. The first signal 201 is shifted to the second signal in the y-direction.

FIG. 17 shows a graph of a typical signal of the resistances mapped to each pedal 102, 106 for a high cadence of a pushing rider, without motor support.

The course of the first period p1 and the second period p2 and their position relative to each of them is nearly the same as shown in FIG. 16. Compared to FIG. 16 the first signal 201 has a shorter plateau on its maximum point. It is nearly one-fourth of the period m1.

The middle m3 of the ramp period p3 of the ramp function 206 is shifted in negative x-direction relative to the middle m1 of the first period p1. The minimum of the second signal 202 is shifted to the middle m1 of the first period p1 by one-fourth of the first period.

The first signal 201 and the second signal 202 are more delayed relative to the ramp function 206 as shown in FIG. 16.

On each crossing point 207 of the first graph 201 and the second graph 202 a left pedal is on its highest y-position. The first pedal is the pedal, which is arranged on the left side of the spindle 10. The left side is the side, which is on the left side of the spindle 10, while the spindle 10 is moving a total moving direction.

The evaluation unit determines the control signal to the electrical motor that drives the spindle 10 over the freewheeling device 108 based on the signals of the angular encoder and the first and the second strain gauges shown above.

FIG. 18 shows a cross-section view along the intersection line AA of the load cell 5 with the spindle 10 mounted in the motor housing 3 as shown in FIG. 8.

The motor housing 3 is cut along the intersection line AA as shown in FIGS. 5 and 8.

The load cell 5 is arranged on the motor housing 3. Between each flap 62, 65 with each flap end 63, 66 and the motor housing 3 is a clearance in y-direction. In z-direction, the load cell 5 is fixed with a holding plate 31. The holding plate 31 is fixed to the motor housing by screws 32. The holding plate 31 comprises a central hole, and the spindle 10 fits through this hole. The hole comprises a sealing lip on its inner edge. The sealing slip protects the load cell 5 against environmental influences.

As shown in FIG. 2, the external force fₑ acts on the first pedal 102. The external force fₑ is a force along the y-direction and acting mainly in negative y-direction. The first pedal crank 101 transfers the external force fₑ from the first pedal 102 through the first pedal spindle 104 to the first pedal crank 101. The first pedal 102 is rotatable around the first spindle symmetrical axis 104, as shown in FIG. 2. So, the first pedal 102 stays in a horizontal position.

The first crank 101 is rotatable around the symmetrical axis 100. The first pedal crank 101 is mounted to the first spindle end 103 to transfer the external force fₑ to the spindle 10.

The spindle 10 transfers the external force fₑ to the first bearing 7 and the second bearing 9. The first inner bearing ring 72 of the first bearing 7 takes up a first force f₁, which is part of the external force fₑ. The second inner bearing 92 of the second bearing 9 takes up a second force f2, which is also part of the external force fₑ. The sum of the first force f₁ and the second force f₂ is equal to the external force fₑ. The first inner bearing ring 72 and the second inner bearing ring 92 transfer each force f₁, f₂ to each rolling roller 73, 93 of each bearing 7, 9. Each rolling roller 73, 93 arranges each inner bearing ring 72, 92 rotatable to each outer bearing ring 71, 91.

The support ring 61 takes up the first bearing 7. The first bearing 7 transfers the first force f₁ to the support ring 61.

The support ring 61 transfers the first force f₁ to the first flap 63 and to the second flap 66.

The external force fₑ, the first force f₁, and the second force f₂ are vertical forces. Vertical forces are acting in the y-direction.

In an embodiment not shown here, the external force fₑ is acting on the second pedal 106. Like explained above, the second pedal 106 transfers the external force fₑ through the second pedal spindle 109 to the second pedal crank 105. The second pedal is rotatable around the second spindle 109 with the second spindle symmetrical axis 131, as shown in FIG. 2.

The second crank 105 transfers the external force fₑ to the spindle 10 and is rotatable around the spindle symmetrical axis 100, as shown in FIG. 2. The second crank 105 is mounted to the second end 107 of the spindle 10. The external force fₑ, which is transferred to the spindle is in the same way as explained above transferred through the first bearing 7, the second bearing 9, and the load cell 5 to the motor housing 3.

A chain 114, which is not shown here, transfers the horizontal forces fₓ₁, fₓ₂ to the deflector blade 110. The first horizontal force fₓ₁ pulls the deflector blade 110 in horizontal x-direction. The second horizontal force fₓ₂ pushes the deflector blade in horizontal x-direction.

The deflector blade 110 transfers the horizontal forces fₓ₁, fₓ₂ to the spindle 10. The spindle 10 also transfers the horizontal forces fₓ₁, fₓ₂ through the ball bearings 7, 9, as explained above, to each ball bearing seat. The horizontal forces fₓ₁, fₓ₂ are separate forces to the forces fₑ, f₁, f₂ and are not further considered here.

The second ball bearing 9 transmits the second force fₓ₂ to the motor housing 3.

Due to the transmitted first force f₁, the first strain gauge 64 measures a change of length of the first flap 62. The second strain gauge 67 also measures a change of length of the second flap 65 depending on the first force f₁. Each Strain gauge 64, 67 changes its resistance due to the change of length.

An evaluation unit 8, shown in FIG. 1 determines the resistance of each strain gauge 64, 67. Due to a predefined material expand coefficient the evaluation unit 8 calculates a force, which is measured with each strain gauge 64, 67, depending on the change of resistance of each strain gauge, 64, 67 and calculates the first force f₁.

The strain gauges 64, 67 are arranged to measure mainly the change of length in radial flap direction, as shown in FIG. 1.

As shown in FIG. 10, each strain gauge 64, 67 comprises a vertical strain gauge and a horizontal strain gauge. For measuring the change of length of each flap 62, 65 only the vertical part 641 of each strain gauge 64, 67 is used. The first horizontal part of each strain gauge 64, 67 is used to measure a change of length due to a temperature change. This determined temperature change is used later to calculate a drift compensation.

Each strain gauge 64, 67 can be part of a Half-bridge circuit. For example, a voltage of 36 Volt is connected to each outer end of the strain gauge. Due to a change of each resistances the relationship between the voltage drops in the first part 641 and the second part 642. Depending on this relationship, a resistance of each part 641, 642 is calculated.

Further, each flap 62, 65 transfers the first force f₁ to each flap end 63, 66. The flap end 63, 66 transfers each part of the first force f₁ to the load cell seat 68 of the motor housing 3, where the load cell 5 is taken up.

Additional to the first strain gauge 64 and the second strain gauge 67, the motor unit 1 also comprises the angular detector 11. The angular detector 11 is attached to the load cell 5 to detect a change of position of the spindle 10 relative to the spindle symmetrical axis 100. The hall sensor 111 of the angular detector 11 has a fixed position relative to the magnetic ring 112 and detects a change of the magnetic field from the magnetic ring 112, which is connected to the spindle 10. A change in position of the magnetic ring 112 indicates a change in position of the spindle 10. Further the magnetic ring 112 comprises a first marker and the spindle comprises a second marker. In case that, the angular encoder detects the absolute position, it is required to match the first marker with the second marker while assembly.

Depending on the change of position of the spindle 10 a relative position of the first pedal crank 101 is determined through the evaluation unit 8. Depending on a position calibration of the spindle 10 the absolute position of the spindle 10 is determined. Due to the absolute position of the spindle 10, an absolute position of the first pedal crank 101 is determined. Depending on the absolute position of the first pedal crank 101 a position of the pedal 102 relative to the spindle 10 is calculated.

Considering that, the external force fₑ is acting to the pedal 102 mainly when the first pedal 102 is more in positive x-direction than the spindle 10, it is determined on which pedal the external force fₑ is acting on.

Depending on a refined ratio of the first force f₁ and the second force f₂ the evaluation unit 8 determines the external force fₑ.

The external force fₑ is applied alternating between each pedal 102, 106. The force fₑ is mainly applied to the pedal 102, 106, which is moving downwards in the negative y-direction.

As shown in FIG. 13, a first external force fe1 acts on the first pedal 102 and a second force fe 2 acting on the second pedal 106. The external force fe1, fe2, which is applied to the pedal 102, 106, which is moving downwards is bigger than the force on the other pedal 102, 106. For example, if the first pedal 102 is going downwards the first external force fₑ₁ is bigger than the second external force fₑ₂.

As shown in FIG. 13, the first pedal 104 is relative to the y-position in a higher position than the second pedal 106. Therefore, the first external force fₑ₁ is bigger than the second external force fₑ₂. Even in this position, the second external force fₑ₂ has a contribution to the total external force fₑ, which is acting on the spindle 10.

The person who is providing the external forces fₑ₁, fₑ₂ needs to keep balance so that the second external force fₑ₂ is bigger than zero.

As shown in FIG. 14, the pedals 102, 106 are nearly on equal height relative to the y-position. In this case, the external force fₑ₁, fₑ₂, which is acting in a pedal direction is bigger. For example, if the pedals are rotating counterclockwise around the spindle symmetrical axis 100 the first external force is bigger than the second external force fₑ₂. The person who is providing the first external force fₑ₂ must keep its balance the second external force fₑ₂ is bigger than zero, as explained above.

FIG. 15 shows a line graph with two lines. The first graph 201 shows the resistance of the second strain gauge 65. The first graph 201 has several minimums and maximums. At each minimum of the first graph 201, the first force fₑ₁ starts acting on the first pedal 102. While the first pedal 102 is going downwards the resistance is changing from its maximum to its minimum. With each repeat of the rotation of the first pedal 102 the first graph 201 is repeating.

As explained above, the second graph 202 shows the resistance of the first strain gauge 62. On each minimum, the second pedal 106 is in its lowest x-position.

A change of each graph 201, 202 is equal to a half-turn of the pedals 102, 106 around the spindle symmetrical axis 100, as shown in FIG. 2

Due to the fact that always a small external force fₑ, for example the weight force, is acting on the spindle 10, each graph 201, 202 has an offset o1 between the baseline 210 and the zero point.

Due to a ball bearing clearance of the first bearing 7 and because of other reasons, the change of resistance of one strain gauge 62, 64 is delayed with respect to the change of resistance of the other strain gauge 62, 64. Therefore the maximum of one graph 201, 202, and the minimum of the other graph 201, 202 have not the same x-position. Graphs 201, 202 are delayed to each. Also, between the first flap with its first flap end, which are not shown here, and the load cell carrier seat, which is also not shown here, is a clearance. Due to these clearances the maximum of the second graph 202 has a plateau.

Considering the offset o1 and the delay, the evaluation unit 8 determines a zero-point calibration, which is applied to the determined first force f1. Depending on this the external force fe is calculated.

As shown in FIGS. 16 and 17 the hall sensor signal 205 is used to calculate the ramp function 206. The ramp function 206 is calculated by summing up each absolute value of the hall sensor signal 205 and counting the number of signals. After one turn of the spindle 10 equal to 144 hall sensor signal changes the ramp function 206 is set to zero. This repeats for each turn.

FIG. 16 shows the graphs at a low cadence while FIG. 17 is showing the graphs at a high cadence. Comparing both figures the ramp function is shifted in the graph showing the high cadence is shifted more in negative x-direction than in FIG. 16 relative to the first graph 201 and the second graph 202. This means the relationship between the ramp function 206 and graphs 201, 202 is depending on the cadence. When the spindle 10 has a high cadence, a centrifugal force is acting on the spindle 10. The centrifugal force is also measured with each strain gauge 64, 67. Therefore the centrifugal force is also part of the determined first force f1 but is not part of the external force fe. Determining the real external force means to compensate the centrifugal force. This is done by the evaluation unit 8.

In one embodiment, the evaluation unit 8 takes the ramp function 206 and the graphs 201, 202 into account and calculates the absolute pedal position. With that knowledge, according to which at each minimum of each graph 201 the first pedal 102 is in its lowest position, the ramp function is calibrated to this position. The calibration for the second graph 202 and the second pedal 106 works in a similar way.

In a further embodiment, the evaluation unit 8 smoothens the measured resistances of the first strain gauge 64 and the second strain gauge 67. The smoothing is done with a low pass filter. A signal from each strain gauge 62, 66 passes through the low pass filter. If the signal frequency is lower than a selected cut-off frequency then the signal passes the low pass filter.

If the signal frequency of the signal is higher than the selected cut-off frequency the low pass filter attenuates the frequencies with a higher frequency than the cut-off frequency. Measurement errors and noise of the resistance signals are smoothened out in this way.

In a further embodiment, the evaluation unit 8 applies a levelling to the measured resistance of each strain gauge 64, 67. The levelling compensates for an error of measurement corresponding to a heating of the strain gauges 64, 67. If the strain gauges 64, 67 are getting warm the relation between the resistance and the change of length changes. This means the predefined relation between resistance and the change of length is inaccurate.

Thus, the evaluation unit 8 calculates a levelling compensation and applies this compensation to the measured resistance. This levelling compensation is an offset, which is applied to each strain gauge 64, 67. The levelling compensation is applied to the measured values of each resistance of the strain gauges 64, 67 after a predefined span.

In a further embodiment, depending on the absolute position of the pedal cranks 101, 105 and the external force fₑ a torque is determined. Depending on the position of the pedals 102, 106 the position of the pedal cranks 101, 105 and within the position of the spindle 10 an effective lever arm length of the pedal is calculated.

A lever arm length of the pedal crank 101, 106 is predefined and saved to the evaluation unit 8. When the position of the pedal 102, 106, changes also a vertical distance between pedal 102, 106 along with the pedal crank 101, 105 and the spindle symmetrical axis 100 changes. The effective lever arm length is equal to the distance between the pedal 102, 106, and the spindle symmetrical axis 100. Taking the effective lever arm length into account, the evaluation unit 8 determines depending on the calculated external force fₑ the torque.

In a further embodiment, the signal that determines the torque that the electric motor provides to the spindle 10 is calculated according to the following levels.
Level 1: sieving of the strain gauge signals
Level 2: zero-point adjustment of the spindle 10
Level 3: zero-point adjustment of the electrical signals
Level 4: calculation of the resulting force on the spindle
Level 5: calculation of the equalizing force
Level 6: evaluation of the pedal position
Level 6: calculation of the spindle torque/electric motor control signal

While a calculation of the spindle torque/electric motor control signal can be done with level 1 information only, the computing precision increases with higher levels of information. The design of the application provides a system that permits individual levels of information to be tested and adjusted at one and the same electric drive.

In practice, the zero-point of the strain gage signals can be calculated after only 2 pedal revolutions. That zero-point is constantly adjusted.

The resulting force can be calculated by the difference of the force of the two strain gauges. The two strain gauge signals amplifiers can be adjusted via HPF. The amplifier for the right pedal should be adjusted higher than the amplifier for the right pedal.

The equalized force is the force that the pushing biker also asserts with the passive leg. The equalized force is calculated after about two pedal revolutions, after having a reliable signal offset. The equalized force is limited to between 10N and 200N, because of practical considerations.

It is further possible to re-adjust the equalized force after one pedal revolution or after half a pedal revolution.

The upper strain gauge can never have if the right pedal is behind the actual right line through the spindle center.

FIG. 19 shows a further embodiment of a load cell 5′ in a perspective front view from the first end of the spindle, which is not shown here.

The load cell 5′ has an anchor flap 250 that protrudes with an angle of about 90° degrees from the symmetry axis 100 of the support ring 61. A fixing pinhole 251 is provided within the anchor flap 250, the symmetry axis of the fixing pinhole 251 being essentially parallel to the symmetry axis 100 of the support ring 61.

In a mounted state of the load cell 5′ in the motor housing 3, a fixing pin (not shown here) is inserted into the fixing pinhole 251 and into a corresponding anchor hole in the motor housing 3. That fixing pin transmits horizontal forces of the load cell 5′ to the motor housing 3, thereby preventing the spindle from moving horizontally because of horizontal forces on the spindle, caused for example by the bicycle chain.

The horizontal arrangement of the anchor flap 250, as compared with the vertical arrangement of the first flap 62 and the second flap 65 which carry the first strain gauge 64 and the second strain gauge 67, provides that the first strain gauge 64 and the second strain gauge 67 are kept out of the area of deformation that these horizontal forces cause in the load cell 5′. That improves the measurement precision of the vertical forces that are transmitted by the spindle to the load cell 5′, different from the solution shown in FIG. 5, distance pieces between the lateral sides of the first flap 62 and the neighboring screws 32, and between the lateral sides of the second flap 65 and the neighboring screws 32. Not only provides the design with the anchor flap 250 and the fixing pin in the fixing pinhole 251 better measure results of the vertical forces, there is also no wear and tear on the distance pieces because they are no longer required.

FIG. 20 shows a front view of the external force measurement unit of FIG. 20.

The angular decoder in FIG. 21 is a pair of conventional Hall sensors 255, 256 that are mounted at the load cell, immediately above the spindle 10 that is provided with a flux groove ring 280.

The precision of the device is increased by using two Hall sensors 255, 256 and by biasing the spindle 10 with a permanent magnet 265 that is placed near the Hall sensors 255, 256, at a position immediately above the Hall sensors 255, 256 and above the spindle 10.

FIG. 21 shows a detailed view of the area marked as “CC” in FIG. 20.

The magnetic flux through the Hall sensors 255, 256 is provided by a series of short flux groves 282, 283 in the spindle 10 which are annually arranged immediately under the Hall sensors 255, 256.

Each one of these flux grooves 282, 283 extends longitudinally in parallel to the symmetry axis of the spindle 10, and these grooves 282, 283 are arranged on a circumference in the outer cylindrical surface of the spindle 10. A reference flux groove 282 of these grooves has a smaller width than the other flux grooves 283. The Hall sensors can detect the change in magnetic flux that these flux grooves 282, 283 cause when the series of flux grooves 282, 283 moves under the Hall sensors 255, 256, upon rotating the spindle 10 while the Hall sensors 255, 256 stand still together with the motor housing 3, and the changing values of the Hall sensor signals provide an angular position of the spindle 1′0 with respect to the Hall sensor 255, 256 and the motor housing 3. The reference flux groove 282 causes a change in the Hall sensors signal that is different from the changes in the Hall sensor signals that are caused by the regular flux grooves 283, and that provides for detecting an absolute angular position of the spindle 10 with respect to the Hall sensors 255, 256.

There is also one reference flux shoulder 281 between these flux grooves 282, 283 that has a larger width in circumferential direction than the flux shoulders between the other flux grooves 282, 283. That wider reference flux shoulder 281 causes a change in the Hall sensor signals that is different from the changes in the Hall sensor signals that are caused by the regular flux shoulders, and that provides for detecting an absolute angular position of the spindle 10 with respect to the Hall sensors 255, 256.

### Example 1

External force measurement unit (4) for measuring an external force (fₑ), the external force measurement unit (4) comprising a first strain gauge (64) and an evaluation unit (8), which is further adapted to determine the external force (fₑ)

### Example 2

External force measurement unit (4) according to Example 1, wherein the external force measurement unit (4) is applied to a spindle (10).

### Example 3

External force measurement unit (4) according to one of the previous examples comprising a load cell (5) with a support ring (61), wherein a first flap (62) and a second flap (65) are arranged on the support ring (61), wherein the second flap (65) is arranged opposite to the first flap (62) on the support ring (61), wherein each flap (62, 65) is arranged in a radial direction to the outside of the outer ring (61), and a first flap end (63) and a second flap end (66) being arranged at respective ends of the first flap (62) and the second flap (64).

### Example 4

External force measurement unit (4) according to one of the previous examples, wherein the first strain gauge (64) is arranged on the first flap (62), wherein depending on a change of length of the first flap (62) due to a material expand the first strain gauges (64) is adapted to change their respective resistance.

### Example 5

External force measurement unit (4) according to one of the previous examples comprising a second strain gauge (67), which is arranged on the second flap (65), wherein depending on a change of length of the second flap (65) due to a material expand the second strain gauge (67) is adapted to change their respective resistance.

### Example 6

External force measurement unit (4) according to one of the previous examples comprising a first bearing support (6) to take up a first bearing (7) in a first bearing seat (68).

### Example 7

External force measurement unit (4) according to one of the previous examples comprising the first bearing (7) with a first outer ring (71), wherein the first outer ring (71) is mounted to the first bearing seat (68) to transmit a first force (f₁), wherein the external force (fₑ) comprises the first force (f₁), which is transmitted to the first bearing (7) from the spindle (10) to a first inner ring (72) and a second force (f₂), which is absorbed by an adapted second bearing (9), and the first inner ring (72) is connected to the first outer rolling ring (71) through a first bearing element (73) to transmit the first force (f₁) from the adapted spindle (10).

### Example 8

External force measurement unit (4) according to one of the previous examples, wherein the evaluation unit (8) is adapted to measure a resistance of the second strain gauge (67) to determine the external force (fₑ)

### Example 9

External force measurement unit (4) according to one of the previous examples, wherein the evaluation unit (8) is further adapted to determine an offset of the external force (fe) being induced by the weight of the spindle (10), and which is further adapted to determine a position of a lever arm of the spindle (10) and to determine the external force (fₑ), which is applied to the adapted spindle (10) based on the measured resistance and the determined offset of the first force (f₁).

### Example 9

External force measurement unit (4) according to one of the previous examples further comprises a motor housing (3).

### Example 10

External force measurement unit (4) according to one of the previous examples, wherein the first flap end (63) and the second flap end (66) are adapted to mount the load cell (5) to a load cell carrier seat (51) on the motor housing (3) of the spindle (10).

### Example 11

External force measurement unit (4) according to one of the previous examples, wherein the second outer ring (91) is mounted to a second rolling support of the motor housing (3).

### Example 12

External force measurement unit (4) according to one of the previous examples, wherein the evaluation unit (8) is smoothing the measured resistance of the strain gauges (64, 67) over time through a low pass filter.

### Example 13

External force measurement unit (4) according to one of the previous examples, wherein the evaluation unit (8) is determining a drift in the measured resistances of the first strain gauge (64) and the second strain gauge (67) over time

### Example 13

External force measurement unit (4) according to one of the previous examples, wherein the evaluation unit (8) is recalibrating the first strain gauge (64) and the second strain gauge (67) by applying a drift compensation after a predefined time span.

### Example 14

External force measurement unit (4) according to one of the previous examples further comprises a freewheel (108), which is form-fitted connected with the spindle (10).

### Example 15

External force measurement unit (4) according to one of the previous examples further comprising an angular encoder (11) to determine a radial position of the spindle (10).

### Example 16

External force measurement unit (4) according to one of the previous examples further comprises the spindle (10), which is received inside the first bearing ring (72) of the first bearing (7), and is received inside the second bearing ring (92) of the second bearing (7), wherein the spindle (10) applies the first force (f₁) to the first bearing ring (72) and a second force (f₂) to the second inner bearing ring (92), wherein the first force (f₁) and the second force (f₂) are parts of the external force (fₑ).

### Example 17

External force measurement unit (4) according to one of the previous examples, wherein the external force (fₑ) is applied to at least one end (103,107) of the spindle (10) through a lever arm (101, 105).

### Example 18

External force measurement unit (4) according to one of the previous examples, wherein the evaluating unit (8) is calculating the torque depending on the calculated force (fₑ) and an effective lever arm length of each the lever arm (101, 105), which is depending on the position of the spindle (10).

### Example 18

Electrically assisted bicycle with an external force measurement unit (4) according to one of the previous examples 1 to 17.

### Example 19

External force measurement unit (4) for measuring an external force (fₑ) applied to a spindle (10), the external force measurement unit (4) comprising:
a load cell (5) with a support ring (61),
wherein a first flap (62) and a second flap (65) are arranged on the support ring (61), wherein the second flap (65) is arranged opposite to the first flap (62) on the support ring (61),
wherein each flap (62, 65) is arranged in a radial direction towards the outside of the support ring (61),
a first strain gauge (64), which is arranged on the first flap (62) and a second strain gauge (67), which is arranged on the second flap (65),
an evaluation unit (8) for measuring the resistance of the first strain gauge (64) and the resistance of the second strain gauge (67)
a first bearing support (6) for taking up a first bearing (7) in a first bearing seat (68), wherein the first bearing (7) is adapted to take up a rotating spindle (10).

### Example 20

External force measurement unit (4) according to example 19, wherein the resistance of the first strain gauge (64) is measured separately from the resistance of the second strain gauge (67).

### Example 21

External force measurement unit (4) according to example 19 or example 20, wherein there are exactly two flaps with strain gauges provided, namely a first flap (62) and a second flap (65).

### Example 22

Magnetic angular position encoder for a rotating spindle (10) in the vicinity of the external force measurement unit (4), wherein the spindle (10) is provided with magnetic material that causes a Hall sensor to issue a signal upon rotation of the spindle 10, a plurality of flux grooves extending longitudinally in parallel to the symmetry axis of the spindle (10), the flux grooves being arranged on a circumference in the outer cylindrical surface of the spindle (10).

### Example 23

Magnetic angular position encoder for a rotating spindle according to example 22, wherein there is at least one reference flux groove of these flux grooves that has a different width in circumferential direction than some or all other flux grooves and/or that reference flux groove has a depth that is different from the depth of some or all other flux grooves.

### Example 24

Magnetic angular position encoder for a rotating spindle according to examples 22 or 23, wherein there is at least one reference flux shoulder between these flux grooves that has a different width in circumferential direction than the flux shoulder between some or all other flux grooves.

### LIST OF REFERENCE NUMERALS

1 Motor unit
1a Motor
2 Electric motor
3 Motor housing
4 External force measurement unit
5 Load cell
6 First bearing support
7 First bearing
8 Evaluation unit
9 Second bearing
10 Spindle
11 Angular encoder
12 Battery holder
31 Holding plate
32 Screw
33 First fastening element
34 Second fastening element
35 Sealing lip
51 Load cell carrier seat
61 Support ring
62 First flap
63 First flap end
64 First strain gauge
65 Second flap
66 Second flap end
67 Second strain gauge
68 First bearing seat
69 Mechanical guiding
71 First outer ring
72 First inner ring
73 First bearing element
91 Second outer ring
92 Second inner ring
93 Second bearing elements
100 Spindle symmetry axis
101 First crank
102 First pedal
103 First end
104 First symmetry axis
105 Second crank
106 Second pedal
107 Second end
108 Free wheel
109 Second symmetry axis
110 Deflector blade
111 Hall sensor
112 Magnetic ring
113 Plastic cover
114 Chain
130 First pedal spindle
131 Second pedal spindle
201 First graph
202 Second graph
205 Hall sensor signal
206 Ramp function
207 Cross point
210 Baseline
250 anchor flap
251 fixing pin hole
255 first hall sensor
256 second hall sensor
257 PCB
258 PCB mounting screw
259 anchor flap
260 fixing pin
265 permanent magnet
280 flux groove ring
281 reference shoulder
282 reference flux groove
283 flux groove
fe External force gauge
f1 First force
f2 Second force
o1 Offset
p1 First period
p2 Second period
m1 Center of a first period
m3 Center of a third period
a1 First amplitude
a2 Second amplitude
a3 Third amplitude
fx1 First horizontal force
fx2 Second horizontal force
fe1 First external force
fe2 Second external force

1. An external force measurement unit for measuring an external force applied to a spindle, the external force measurement unit comprising:
a load cell comprising:
a support ring;
a first flap arranged on the support ring,
a second flap arranged opposite to the first flap on the support ring, wherein each of the first flap and the second flap is arranged in a radial direction towards an outside of the support ring, and
a first bearing support adapted to take up a first bearing in a first bearing seat, wherein the first bearing is adapted to take up a rotating spindle,
a first strain gauge arranged on the first flap,
a second strain gauge arranged on the second flap, and
an evaluation unit for measuring a resistance of the first strain gauge and a resistance of the second strain gauge, wherein the resistance of the first strain gauge is measured separately from the resistance of the second strain gauge.

2. The external force measurement unit according to claim 1, with a first flap end and a second flap end being arranged at respective ends of the first flap and the second flap.

3. The external force measurement unit according to claim 1, wherein the evaluation unit is further adapted to:
determine an offset of the external force,
determine a position of a lever arm of the spindle, and
determine the external force applied to the spindle based on the resistance of the first strain gauge, the resistance of the second strain gauge, and the offset.

4. The external force measurement unit according to one of claim 1, further comprising a motor housing, wherein the first flap and the second flap are taken up in a load cell carrier seat in the motor housing.

5. The external force measurement unit to claim 1, wherein the evaluation unit is configured to smooth the measured resistances of the strain gauges over time through a low pass filter.

6. The external force measurement unit according to claim 1, wherein the evaluation unit is configured to:
determine a drift in at least one of the resistance of the first strain gauge and the resistance of the second strain gauge over time; and
recalibrate the first strain gauge and the second strain gauge by applying a drift compensation.

7. The external force measurement unit according to claim 1, further comprising a freewheel connected to the spindle.

8. The external force measurement unit according to claim 1, further comprising an angular encoder configured to determine a radial position of the spindle.

9. The external force measurement unit according to claim 1, wherein the spindle is received inside a first bearing ring of a first bearing and inside a second bearing ring of a second bearing.

10. The external force measurement unit according to claim 4, wherein the load cell is provided with a vertical guiding assembly that interacts with the motor housing.

11. The external force measurement unit according to claim 10, wherein the vertical guiding assembly is provided as an anchor flap defining a fixing pinhole, a symmetry axis of the fixing pinhole being essentially parallel to a symmetry axis of the support ring.

12. The external force measurement unit according to claim 11, wherein in a mounted state of the load cell in a motor housing, a fixing pin is inserted into the fixing pinhole and into a corresponding anchor hole in the motor housing.

13. An electric drive for an electrically assisted bicycle, the electric drive comprising:
an electric motor, and
an external force measurement unit according to claim 1.

14. The electric drive according to claim 13, further comprising a spindle is provided in the vicinity of the external force measurement unit, wherein the spindle is provided with magnetic material that is configured to cause a Hall sensor to issue a signal upon rotation of the spindle, a plurality of flux grooves extending longitudinally in parallel to the symmetry axis of the spindle, the flux grooves being arranged on a circumference in an outer cylindrical surface of the spindle.

15. The electric drive according to claim 14, wherein a reference flux groove of the plurality of flux grooves has a different width in a circumferential direction and/or a different depth than other flux grooves of the plurality of flux grooves.

16. The electric drive according to claim 14, wherein a reference flux shoulder between these flux grooves has a different width in a circumferential direction than that of a flux shoulder between adjacent flux grooves of other flux grooves of the plurality of flux grooves.

17. An electrically assisted bicycle with an electric drive according to claim 13.

18. The electric drive according to claim 13, further comprising a motor housing.

19. The electric drive according to claim 14, wherein the spindle is configured to receive a pedal crank at each of two spindle ends of the spindle.
